(19) United States
(12) Patent Application Publication
(10) Pub. No.: US 2025/0284828 A1
(43) Pub. Date: Sep. 11, 2025

(54) Utilizing a Large Language Model to Modify Digital Data of an Entity in Response to Digital Data Requirements Changes

(71) Applicant: OneTrust LLC, Atlanta, GA (US)

(72) Inventor: Ashok KALLARAKUZHI, Atlanta, GA (US)

(21) Appl. No.: 18/595,791

(22) Filed: Mar. 5, 2024

(51) Int. Cl. G06Q 40/06

(52) U.S. Cl. CPC G06F 21/62; H04L 63/102

(57) ABSTRACT

Methods, systems, and non-transitory computer readable storage media are disclosed for managing computing systems to comply with system requirements frameworks that indicate specific requirements on how the computing systems should handle certain data types. In response to detecting a change to one or more digital data requirements of a system requirements framework, the disclosed systems access a configuration profile of an entity and utilize a large language model to determine if data assets or data processing operations comply with the changes to the digital data requirements. In response to determining a configuration gap of the configuration profile based on detected changes to the digital data requirements, the disclosed systems utilize a large language model to generate tasks for correcting the configuration gap. The disclosed systems generate one or more tasks by modifying data assets, data processing operations, or other digital data associated with the entity.

### BACKGROUND

Advances in computer processing power and data storage capacities have led to a significant increase in the volume and types of data transferred to digital environments for processing and management. Specifically, many entities utilize computing devices to store, maintain, analyze, transmit, and/or perform a number of computational operations on different types of data in connection with a range of data processing activities. Computing systems handling (e.g., collecting, receiving, transmitting, storing, maintaining, processing, sharing, and/or the like) certain types of digital data are often subject to requirements for handling such data (e.g., internally for an entity or externally via one or more regulatory bodies). More specifically, many data processes for handling data (e.g., personally identifiable information) are subject to various legal frameworks, regulatory mandates, and industry standards that include requirements for handling such types of data in specific ways (e.g., via certain computing processes, limitations, or capabilities) for security and privacy reasons.

Organizations face the challenge of managing data in computing environments in compliance with current policies and organizational standards. For instance, situations may arise where data, such as a personally identifiable information, is retained longer than current frameworks allow. This failure to adhere to data retention policies not only poses legal and regulatory risks but also increases the potential for data breaches and compliance violations. Issues such as sensitive data ending up in unintended locations and data being accessed or used inappropriately further compound these challenges.

To illustrate the complexities involved, many systems require that financial data associated with payment cards be handled according to the Payment Card Industry Data Security Standard (“PCI DSS”), which specifies twelve different requirements for compliance with a current set of standards or regulations for protecting cardholder data. Accordingly, computing systems that are involved in handling such financial data are required to implement and enforce specific digital data requirements that include data asset structures, applications, or communications methods to be in compliance with the PCI DSS. For example, some digital data requirements include installing and maintaining a firewall configuration to protect cardholder data, implementing data retention and disposal policies for cardholder data storage, and masking primary account numbers (PANs) when displayed via client devices to prevent unauthorized users/systems from having access to the full PANs.

Due to the diverse set of requirements for different types of digital data, monitoring evolving requirements and managing digital content to satisfy the current digital data requirements within computing systems can be a challenging task. In particular, due to the complexity and extent of many large scale computing systems (e.g., in a credit card processing system), digital data repositories including digital content items for various data processes may include a large number of individual digital content items. Further, entities may need to monitor and update a variety of data assets (e.g., servers, storage devices, software applications) and data processing operations (e.g., executable code for transferring data between data assets, storing data in a data asset, interfacing with external systems, or other operations involving digital content items) based on changes to associated system requirements frameworks.

Additionally, large scale computing systems can often include data assets and data processing operations in different locations/jurisdictions or associated with different entities, thus invoking different applicable system requirements frameworks that each may include the same or different digital data requirements. Maintaining such computing systems that comply with diverse and changing digital data requirements across different locations can introduce significant technical complexities when monitoring data compliance, satisfying current frameworks (e.g., data policies), and preparing digital data for downstream operations. Furthermore, as frameworks, computing systems, and data contents change over time, adapting computing systems corresponding to the changing data processing operations can introduce additional technical challenges.

### SUMMARY

This disclosure describes one or more aspects of methods, non-transitory computer readable media, and systems that solve the foregoing problems, in addition to providing other benefits, by modifying digital data (e.g., data assets and/or data processing operations) based on detected changes to digital data requirements of a system requirements framework via the use of a large language model. In particular, the disclosed systems generate a mapping between a configuration profile of data assets and data processing operations associated with an entity and a knowledge graph that delineates relationships between entities and digital data requirements of a system requirements framework. Further, based on the mapping, the disclosed systems utilize a large language model to determine whether the configuration profile meets one or more detected changes in the digital data requirements. Moreover, based on the configuration profile and gap rules indicating control actions associated with the system requirements framework, the disclosed systems utilize the large language model to generate tasks for applying modifications to the data assets and/or data processing operations to address configuration gaps in the configuration profile. The disclosed systems thus provide efficient, accurate, and flexible management of computing systems to detect and modify the digital data for a variety of data assets and processing operations within a computing environment. The disclosed systems also provide an efficient graphical user interface for changing, and validating the changes to, the digital data according to controls associated with the digital data requirements.

### BRIEF DESCRIPTION OF THE DRAWINGS

Various aspects will be described and explained with additional specificity and detail through the use of the accompanying drawings.

FIG. 1 illustrates an example of a system environment in which a data configuration modification system can operate in accordance with one or more aspects.

FIG. 2 illustrates an example overview of the data configuration modification system utilizing a large language model to determine computing system modifications based on changes to a system requirements framework in accordance with one or more aspects.

FIG. 3 illustrates an example of mapping relationships between attribute values corresponding to a configuration profile and a system requirements framework utilizing a knowledge graph in accordance with one or more aspects.

FIG. 4 illustrates an example of the data configuration management system determining desired state instructions to correct a configuration gap of a configuration profile by interfacing with a large language model in accordance with one or more aspects.

FIG. 5 illustrates an example of the data configuration management system determining desired state instructions to implement controls to correct a configuration gap based on gap rules in accordance with one or more aspects.

FIG. 6 illustrates an example of the data configuration management system determining and providing tasks for implementing changes to a configuration profile of an entity to a client device in accordance with one or more aspects.

FIG. 7 illustrates an example of a graphical user interface for initiating a compliance check for an entity in accordance with one or more aspects.

FIG. 8 illustrates an example of a graphical user interface for managing task recommendations provided by the data configuration management system in accordance with one or more aspects.

FIG. 9 illustrates an example of a graphical user interface for providing recommended tasks to correct a configuration gap in accordance with one or more aspects.

FIG. 10 illustrates and example of a graphical user interface for requesting approval to implement changes to a configuration profile in accordance with one or more aspects.

FIG. 11 illustrates an example implementation of the data configuration management system in accordance with one or more aspects.

FIG. 12 illustrates an example flowchart of a process for using a large language model to generate tasks for applying modifications to data assets or data processing operations based on changes to digital data requirements in accordance with one or more aspects.

FIG. 13 illustrates an example of a computing device in accordance with one or more aspects.

### DETAILED DESCRIPTION

This disclosure describes one or more aspects of a data configuration management system that uses a large language model to manage compliance of computing systems with system requirements frameworks (e.g., internal or external policies, regulations, or standards) that indicate specific requirements on how the computing systems should handle certain data types. In one or more aspects, the data configuration management system manages digital data objects (e.g., representing data assets and/or data processing operations) associated with an entity based on changes to the system requirements frameworks. In particular, in response to detecting a change to one or more digital data requirements of a system requirements framework, the data configuration management system accesses a configuration profile of an entity and utilizes a large language model to determine if data assets and/or data processing operations comply with the changes to the digital data requirements. Moreover, in response to determining a configuration gap of the configuration profile based on detected changes to the digital data requirements, the data configuration management system utilizes a large language model to generate tasks for correcting the configuration gap. For instance, the data configuration modification system generates one or more tasks for mitigating risks associated with the configuration gap by modifying data assets, data processing operations, or other digital data associated with the entity.

As mentioned, in one or more aspects, the data configuration management system determines that an entity is associated with a system requirements framework by utilizing a knowledge graph to connect a configuration profile of the entity to the system requirements framework. Specifically, the data configuration modification system determines that one or more data assets or one or more data processing operations of the entity should comply with digital data requirements of the system requirements framework for handling specific data types based on the knowledge graph. Additionally, the data configuration modification system detects changes to the system requirements framework (e.g., the digital data requirements) via one or more digital sources (e.g., a data repository monitoring system or a third-party notification source).

In certain aspects, in connection with determining that an entity has data assets or data processing operations impacted by changes to the digital data requirements, the data configuration management system utilizes a framework change processor to determine a configuration gap indicating that one or more attributes of the entity, data assets associated with the entity, or data processing operations associated with the entity are not in compliance with the updated system requirements framework. In particular, the data configuration management system uses the framework change processor to determine a gap rules set including one or more gap rules associated with the system requirements framework to identify one or more desired state instructions in response to determining the configuration gap. For example, the framework change processor can utilize a large language model to generate desired state instructions indicating a desired state of the configuration profile according to the updated system requirements framework (e.g., one or more attribute values of digital assets or digital processing operations) that place the configuration profile in compliance.

According to one or more aspects, the data configuration management system utilizes a regulatory change enactment engine to generate tasks for modifying attributes of the configuration profile of the entity according to the desired state instructions. For example, the regulatory change enactment engine utilizes a large language model to generate tasks for applying modifications to data assets or data processing operations of the entity according to the desired state instructions. To illustrate, the regulatory change enactment engine generates the tasks based on a comparison of a desired state of the configuration profile of the entity relative to a current state of the configuration profile. In some aspects, the regulatory change enactment engine generates tasks associated with generating a risk profile, a control recommendation, or a task recommendation associated with correcting a configuration gap caused by one or more changes to digital data requirements of a system requirements framework. Additionally, in some aspects, the regulatory change enactment engine generates tasks to implement (e.g., automatically or via one or more client devices) control actions for installing one or more controls associated with handling data in view of the system requirements framework. As a simplified example, a task can indicate a control action for installing a control for a “cookie banner” data asset with an “informed consent” attribute with a non-compliant value based on a comparison of the desired state of the configuration profile relative to a current state of the configuration profile for the entity.

In certain aspects, the data configuration management system implements, or causes a computing device to implement, control actions based on the generated tasks. For example, the data configuration management system implements one or more control actions to cause computing devices to install one or more controls in connection with the data assets or the data processing operations and the digital data requirements. To illustrate, the data configuration management system utilizes a software/hardware integration (e.g., via one or more API calls, database operations, or executables installed on the computing devices) to automatically apply a specific control on a data asset or data type associated with the entity according to the digital data requirements. In additional aspects, the data configuration management system provides tools for a user device to implement controls in connection with applying the tasks to manage the attributes of the entity. To illustrate, the data configuration management system generates and displays tasks via a graphical user interface of a computing device for applying modifications to the data assets and/or data processing operations of the entity to address the configuration gaps for complying with the system requirements framework.

Certain aspects described herein can improve upon shortcomings of conventional systems in relation to managing computing systems that manage digital data according to various system requirements frameworks. Specifically, conventional systems lack efficiency, flexibility, and security in connection with complying with various system requirements frameworks.

For example, conventional systems typically include rigid computing system classification structures that fail to adapt to changes in frameworks and/or changes in data assets or digital data that result in the digital data being out of compliance with the system requirements frameworks. Indeed, the large scale nature of many computing systems subject to different data requirements frameworks often results in such conventional systems being out of compliance due to the rigid nature of the computing system classification structures, data management, and their inability to detect violating digital content items in a timely manner.

Furthermore, changes to a particular framework or data asset/data process that lead to non-compliant configurations of data handling by the computing systems of the conventional systems can result in inaccurate use of the data by one or more additional computing systems. To illustrate, if a conventional system fails to identify and correct attributes of a configuration profile that violate a system requirements framework, a computing system executing an additional data process involving the digital content item may generate, transmit, or otherwise handle data in a manner that also violates the system requirements framework or produce data that violates a system requirements framework. For instance, the conventional systems may utilize expired data, incorrectly stored PII, or provide other violating digital data to perform various data processes. This may result in non-compliant handling or generation of digital data in connection with the system requirement framework.

Additionally, many conventional systems lack a comprehensive approach to managing security compliance updates. Existing systems often adopt a fragmented approach to security, employing multiple point solutions to address diverse security threats. In part due to this fragmented approach, many current systems often do not make modifications to correct digital security vulnerabilities in a timely manner. Furthermore, in part due to this fragmented approach, existing systems often struggle with the computational workload and computational complexity of monitoring and satisfying updated security compliance requirements, leading to compliance gaps and potential security breaches.

Certain aspects of the disclosed data configuration management system provide advantages over these conventional systems. For example, the data configuration management system provides improved efficiency, flexibility, and security for computing systems that manage digital data subject to various digital data requirements of a system requirements framework. Specifically, in contrast to conventional systems with rigid computing system structures that do not adapt to changes in connection with different data assets and/or data processing operations, the data configuration management system provides tools for managing digital data and data assets/data processing operations in response to changes to digital data requirements for handling specific data types. Furthermore, the data configuration management system can automatically modify data assets or data processing operations determined to be non-compliant based on the changes to the system requirements framework to bring the data assets or data processing operations into compliance. In additional aspects, the data configuration management system can interact with various computing devices to implement such changes (e.g., automatically or based on device input) and implement various controls to prevent further violations.

More specifically, by leveraging integrations with various data assets (e.g., digital data repositories) to modify digital content according to the generated tasks, the data configuration management system provides tools for quickly and easily correcting digital data that violate various internal or external system requirements frameworks within computing environments. To illustrate, the data configuration management system provides automated tools or graphical user interface tools to easily modify digital content according to the tasks and based on a change to a system requirements framework including the digital data requirements for handling specific data types. In this way, the data configuration management system can streamline data processing tasks by automating task implementation and/or recommending the implementation of tasks which leads to a more efficient use of computational resources and optimized workflows for data compliance operations. Furthermore, the data configuration modification system can utilize a large language model (e.g., by interfacing with the large language model utilizing a framework change processor and a regulatory change enactment engine) to efficiently and accurately determine which data assets or data processing operations should be updated and which actions to take to update the data assets or data processing operations based on the framework changes.

Additionally or alternatively, certain aspects of the data configuration management system improve the accuracy of computing systems that manage digital data in accordance with requirements for a system requirements framework. In particular, the data configuration management system utilizes dynamic generation of desired state instructions based on a configuration gap to accurately indicate relationships between the changes to a system requirements framework and stored digital content associated with an entity (or computer environment). In particular, by generating the desired state instructions utilizing a large language model, the data configuration management system can automatically determine that specific data assets or data processing operations associated with an entity violates a change to a particular system requirements framework. In particular, the data configuration management system reduces the computational load spent searching for digital content violating one or more changes to the system requirements framework and leads to a more efficient computational modification of digital content associated with changes to the system requirements framework. The data configuration management system can also leverage the large language model to suggest and perform control actions to automatically remediate data assets or data processing operations determined to violate the system requirements framework based on the streamlined processes described herein.

Additionally, certain aspects of the data configuration management system generate tasks specifically tailored to the individual entity according to a configuration gap associated with a change in digital data requirements for handling digital data in view of a system requirements framework. In these aspects, the data configuration management system utilizes the unique characteristics of an entity (e.g., configuration profile) to provide customized data processing management and tailored configuration for the computing systems of the entity. For example, by determining/analyzing data objects customized according to entity specific data assets and/or data processing operations, the data configuration management system determines configuration gaps and assists in correcting the configuration gaps through the generation of entity specific tasks.

Additionally, certain aspects of the data configuration management system provide an improved graphical user interface for presenting tasks associated with entity compliance with the system requirements framework. For example, the data configuration management system provides automatic analysis and processing of data with graphical user interface tools for modifying data assets and data processing operations to accurately handle specific data types via the generation and execution of compliance tasks. The data configuration management system also integrates with entity computing systems to automatically communicate with the entity data assets and/or data processing operations affected by a particular compliance task. By communicating with the data assets and/or data processing operations, each of which may have a separate communication interface, and providing the information along with interactive interface elements to view, modify, or otherwise interact with the information corresponding to each of the separate data assets and/or data processing operations, the data configuration management system provides an improved graphical user interface. Specifically, a user of a client device can view and interact with the data from the different data assets and/or data processing operations within a single graphical user interface without requiring the user to access the separate communication interfaces (e.g., via a file browser, web browser, FTP link, application interface) of each data assets and/or data processing operations.

Furthermore, the data configuration modification system can improve security of computing systems handling specific data types. For instance, the data configuration management system provides improved digital data security by managing security compliance updates, providing a system for timely notifications of security updates and compliance requirements, and implementing changes to data assets or data processing operations to secure sensitive data types. As an example, the data configuration modification system can leverage a large language model to detect changes to data security requirements and determine tasks for implementing controls related to technical security features, such as access management requirements or network authentication, to correct configuration gaps associated with an entity's data assets or data processing operations. To illustrate, the data configuration management system can enhance security by providing an automated system for implementing tasks and required controls for an access management system (e.g., requiring strong passwords, requiring two-factor authentication, etc.) or a data storage system (e.g., implementing a specified form of data encryption at rest) in response to changes to a particular system requirements framework. Rather than reacting to issues after they arise, the data configuration management system proactively monitors changes in the system requirements framework, thereby providing tasks for the entity to take preemptive actions to protect sensitive data.

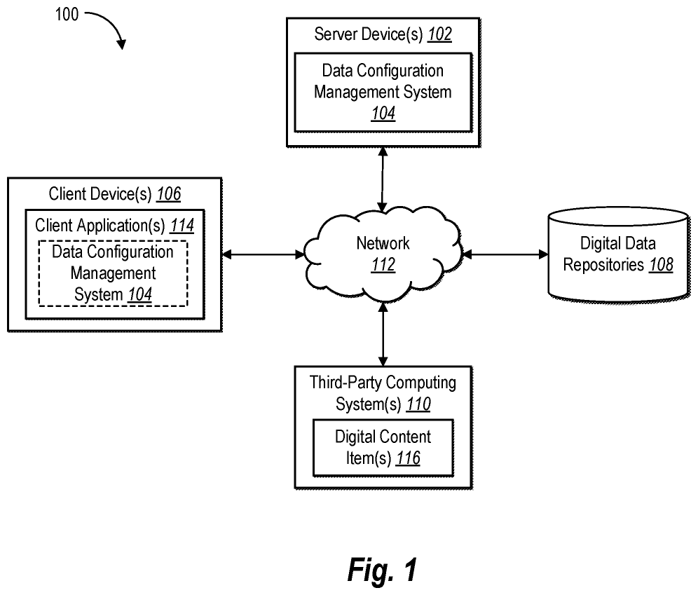

Turning now to the figures, FIG. 1 includes an aspect of a system environment 100 in which a data configuration management system 104 is implemented. In particular, the system environment 100 includes server device(s) 102, client device(s) 106, and third-party computing system(s) 110 in communication via a network 112. Moreover, as shown, the data configuration management system 104 includes digital data repositories 108. FIG. 1 also shows that the client device(s) 106 include client application(s) 114.

As shown in FIG. 1, in one or more aspects, the server device(s) 102 include or host the data configuration management system 104. Specifically, the data configuration management system 104 includes, or is part of, one or more systems that classify digital data from the digital data repositories 108 and/or the third-party computing system(s) 110 (e.g., digital content item(s) 116). For example, the data configuration management system 104 provides tools to the client device(s) 106 for classifying and managing data associated with an entity. In one or more aspects, the data configuration management system 104 provides tools to the client device(s) 106 via the client application(s) 114 for classifying and managing information associated with the entity and/or data that the entity handles. As shown, the client application(s) 114 can include aspects where all or part of the functionality for the data configuration management system 104 is performed by the client application(s) 114.

As used herein, the term “data object” refers to a digital object for tracking or managing systems, software, data sources, entities, or other functions or infrastructure involved in handling specified data for an entity. For example, a data object can include a digital representation of the entity itself, a sub-entity such as subsidiary of the entity, a business unit of the entity, a data asset, or a computing operation. Additionally, a data object can include a “control object” representing a set of requirements associated with a control for handling data in one or more data processes according to a particular system requirements framework.

Additionally, in one or more aspects, a data object can include a “data asset object” representing a computing component for handling a specified data asset for an entity in connection with one or more data processes. For example, the data configuration management system 104 generates/stores a data object representing a data asset including a computing component such as, but not limited to, a computing system, a software application, a website, a mobile application, or a data storage/repository. To illustrate, a data object for a data asset can represent a server device or a digital data repository (e.g., the digital data repositories 108) in the form of a database used for storing specified data. Additionally, a data object for a data asset can represent the third-party computing system(s) 110, or other systems. The data configuration management system 104 thus generates and stores a plurality of data objects (e.g., at the digital data repositories 108) representing different aspects of computing operations associated with the digital content item(s) 116 at the third-party computing system(s) 110 for use in various downstream operations, such as for verifying compliance with one or more system requirements frameworks.

Additionally, as used herein, the term “data processing operation” (or “data process”) refers to a computing process that performs one or more actions associated with specified data. In some aspects, a data processing operation is represented by a data object (i.e., a “data process object”). For example, the data configuration management system 104 generates/stores a data object representing a data processing operation including, but not limited to, a computing process or action corresponding to execution of processing instructions to process, collect, access, store, retrieve, modify, or delete target data. To illustrate, for target data including credit card information and payment information associated with processing a credit card transaction, the data configuration management system 104 generates a data object to represent a data processing operation that collects the credit card information through a form (e.g., webpage) provided via the website and processes the credit card information with the appropriate card provider to process the credit card transaction. Additionally, the data configuration management system 104 can generate mappings or other associations between various data objects (e.g., representing digital content items, data assets, data processing operations) according to one or more mapping operations.

In one or more aspects, the data configuration management system 104 also provides tools for using the data objects to manage functions or infrastructure subject to one or more system requirements frameworks (e.g., data policies) related to various laws, regulations, or standards applicable to an entity. To illustrate, certain types of data are subject to certain “digital data requirements,” which refer to specific implementations of details associated with a system requirements framework via controls for handling (e.g., processed, transmitted, stored) data in a computing environment. Accordingly, the data configuration management system 104 analyzes the data objects (e.g., via one or more data analysis projects) to determine whether the functions or infrastructure represented by the data objects are in compliance with a system requirements framework. More specifically, the data configuration management system 104 determines whether the functions/infrastructure are in compliance with a set of standards or laws for handling specific data types or otherwise configuring an entity's functions or infrastructure in accordance with a corresponding standard (e.g., a set of internal entity practices or external practices set by a regulatory body such as the International Organization for Standardization). As an example, for a system requirements framework that indicates how to retain (e.g., length of time, storage requirements) a particular data type, the digital data requirements can indicate how to apply the system requirements framework to a particular digital content item (e.g., a data retention time for the digital content item or an encryption for the digital content item) within a particular computing environment.

As used herein, the term “control” refers to a tool or function for satisfying a requirement of a system requirements framework for a computing environment. An example of a control is a procedure or practice for handling specific data types that entities are required to follow in connection with a regulation governing security or privacy. For instance, a control can include requirements for handling personally identifiable information, financial information, medical information, legal information, sensitive information, or other data types or subsets of data types in computing devices or transmissions between computing devices. Furthermore, as used herein, the term “control action” refers to an action to install or enact a particular control for handling specific data types. To illustrate, control actions can include actions for redacting specific data types from digital content items, encrypting specific data types, grouping specific data types, excluding specific data types from communications, etc.

According to one or more aspects, the data configuration management system 104 generates or manages data objects by communicating with the digital data repositories 108 and/or the third-party computing system(s) 110. Specifically, the data configuration management system 104 can communicate with the digital data repositories 108 and/or the third-party computing system(s) 110 to determine or otherwise obtain information associated with the data objects. In some aspects, one or more of the client device(s) 106 control or use the third-party computing system(s) 110 and/or the digital data repositories 108 for actions associated with the entity. The data configuration management system 104 may be configured to communicate with the digital data repositories 108 and/or the third-party computing system(s) 110 on behalf of the entity via an integration that is installed on the data configuration management system 104 and is configured with the entity's credentials (e.g., via an integrated data extraction software application). The data configuration management system 104 can obtain metadata or other information about the infrastructure or functions used by the entity and thereby populate attributes of the data objects with this information.

In one or more aspects, the term “data extraction software application” refers to a computing application that operates on a computing device to extract data from the computing device or another computing device. For example, the data configuration management system 104 includes a data extraction software application to access the digital data repositories 108 utilizing credentials (e.g., login information, tokens) and extract (e.g., obtain) data including files, directories, or data within files. Additionally, in some aspects, the data configuration management system 104 utilizes a data extraction software application to install one or more scripts, functions, or components of the data extraction software application at one or more other computing devices (e.g., the digital data repositories 108 and/or the third-party computing system(s) 110).

In additional aspects, the data configuration management system 104 communicates with the client device(s) 106 to obtain information associated with the data objects or to provide information about the data objects for display within the client application(s) 114. For instance, the data configuration management system 104 can obtain, via user input received from a client device(s) 106, metadata or other information about the infrastructure or functions used by the entity and thereby populate attributes of the data objects with this information.

In one or more aspects, the third-party computing system(s) 110 include server devices, individual client devices, or other computing devices associated with an entity. For instance, a third-party computing system includes one or more computing devices for performing a data process involving handling data associated with one or more operations of the entity subject to a particular system requirements framework. To illustrate, the third-party computing system includes one or more server devices that generate, process, store, or transmit payment card processing data subject to PCI DSS in one or more jurisdictions.

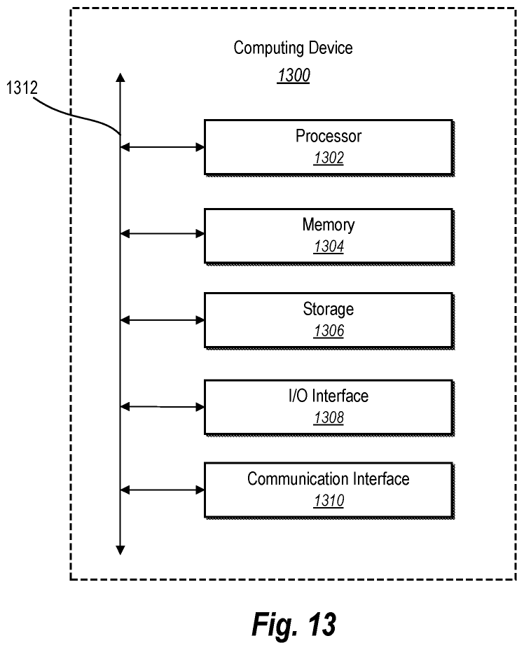

In one or more aspects, the server device(s) 102 include a variety of computing devices, including those described below with reference to FIG. 13. For example, the server device(s) 102 includes one or more servers for storing and processing data associated with control implementation and management. In some aspects, the server device(s) 102 also include a plurality of computing devices in communication with each other, such as in a distributed storage environment. In some aspects, the server device(s) 102 include a content server. The server device(s) 102 also optionally includes an application server, a communication server, a web-hosting server, a social networking server, a digital content campaign server, or a digital communication management server.

In one or more aspects, each of the client device(s) 106 includes, but is not limited to, a desktop, a mobile device (e.g., smartphone or tablet), or a laptop including those explained below with reference to FIG. 13. Furthermore, the client device(s) 106 can be operated by users (e.g., a user included in, or associated with, the system environment 100) to perform a variety of functions. In particular, the client device(s) 106 performs functions such as, but not limited to, accessing, viewing, and interacting with data associated with managing digital data requirements for one or more system requirements frameworks. In some aspects, the client device(s) 106 also perform functions for generating, capturing, or accessing data to provide to the data configuration management system 104 in connection utilizing controls and/or evidence tasks associated with the digital content items for an entity. For example, the client device(s) 106 communicate with the server device(s) 102 via the network 112 to provide information (e.g., user interactions) associated with data objects and digital content items. Although FIG. 1 illustrates the system environment 100 with a plurality of client device(s) 106, in some aspects, the system environment 100 includes a single client device or other client devices. In some aspects, the client device(s) 106 or the server device(s) 102 also host the digital data repositories 108.

Additionally, as shown in FIG. 1, the system environment 100 includes the network 112. The network 112 enables communication between components of the system environment 100. In one or more aspects, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102, the client device(s) 106, the digital data repositories 108, and the third-party computing system(s) 110 communicate via the network using one or more communication platforms and technologies suitable for transporting data and/or communication signals, including any known communication technologies, devices, media, and protocols supportive of data communications, examples of which are described with reference to FIG. 13.

Although FIG. 1 illustrates the server device(s) 102, the client device(s) 106, the digital data repositories 108, and the third-party computing system(s) 110 communicating via the network 112, in alternative aspects, the various components of the system environment 100 communicate and/or interact via other methods (e.g., the server device(s) 102, the client device(s) 106, the digital data repositories 108, and/or the third-party computing system(s) 110 can communicate directly). Furthermore, although FIG. 1 illustrates the data configuration management system 104 and the digital data repositories 108 being implemented separately within the system environment 100, the data configuration management system 104 and the digital data repositories 108 can alternatively be implemented, in whole or in part, by a particular component and/or device within the system environment 100 (e.g., the server device(s) 102). Additionally, in some aspects, the third-party computing system(s) 110 include the client device(s) 106.

In some aspects, the server device(s) 102 support the data configuration management system 104 on the client device(s) 106. For instance, the server device(s) 102 generates/maintains the data configuration management system 104 and/or one or more components of the data configuration management system 104 for the client device(s) 106. The server device(s) 102 generates and provides the data configuration management system 104 to the client device(s) 106 (e.g., as a software application/suite). In other words, the client device(s) 106 obtain (e.g., download) the data configuration management system 104 from the server device(s) 102. At this point, the client device(s) 106 are able to utilize the data configuration management system 104 to manage compliance of data objects and digital content items according to one or more system requirements frameworks independently from the server device(s) 102.

In alternative aspects, the data configuration management system 104 includes a web hosting application that allows the client device(s) 106 to interact with content and services hosted on the server device(s) 102. To illustrate, in one or more aspects, the client device(s) 106 access a web page supported by the server device(s) 102. The client device(s) 106 provide input to the server device(s) 102 to perform compliance management operations, and, in response, the data configuration management system 104 on the server device(s) 102 performs operations to view/manage data associated with digital data processing. The server device(s) 102 provide the output or results of the operations to the client device(s) 106.

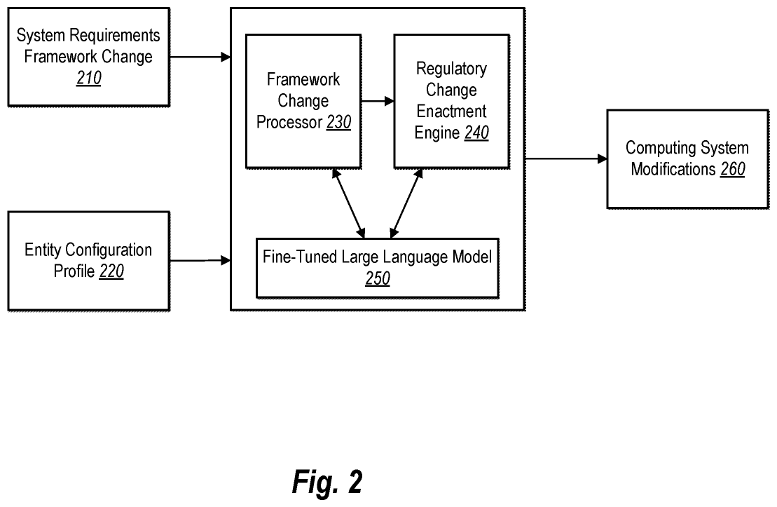

As mentioned, the data configuration management system 104 manages computing systems to modify digital data based on detected changes to digital data requirements of a system requirements framework via the use of a large language model. FIG. 2 illustrates an example overview of the data configuration modification system using a large language model to determine computing system modifications based on changes to a system requirements framework in accordance with one or more aspects.

For example, as illustrated in FIG. 2, the data configuration management system 104 detects a system requirements framework change 210 that includes a change to a digital representation of a system requirements framework for handling specific data types. The system requirements framework change 210 represents functions and infrastructure aligned with a set of standards or laws for handling specific data types in accordance with a corresponding standard. For example, the data configuration management system 104 can detect the change to the digital representation of the system requirements framework (e.g., a change to digital data requirements of the system requirements framework) based on accessing digital content items from a digital data repository, accessing content from a third-party notification source, or receiving a notification from a system requirements framework monitoring system.

To illustrate, the data configuration management system 104 includes a data extraction software application to access digital data repositories utilizing credentials (e.g., login information, tokens) and extract (e.g., obtain) data including files, directories, or data within files. Additionally, in some aspects, the data configuration management system 104 utilizes a data extraction software application to install one or more controls by executing scripts, functions, or components of the data extraction software application at one or more other computing devices (e.g., the digital data repositories 108 and/or the third-party computing system(s) 110). In one or more aspects, the data configuration management system 104 employs an integration of software and hardware (e.g., via one or more API calls, database functions, or software executables installed on the computing devices) to retrieve information from one or more computing devices to determine a system requirements framework change.

As shown, the data configuration management system 104 utilizes an entity configuration profile 220 that includes attributes of an entity, data assets associated with the entity, and/or data processing operations associated with the entity. For example, the entity configuration profile 220 can include a repository for key information associated with an entity. To illustrate, the entity configuration profile 220 can include attributes of an entity comprising entity type, industry, location, size, ownership structure, licenses, and/or brand elements. As additional examples, attributes of an entity can include operational countries, line of business, company size, number of employees, company revenue, operational workflows, data protection protocols, industry-specific regulations, quality assurance requirements, training requirements, cybersecurity controls, and/or business practices for an entity.

In addition, the entity configuration profile 220 can include data assets including computing components such as, but not limited to, a computing system, a software application, a website, a mobile application, a data storage/repository, and/or digital data (e.g., intellectual property, financial records, product data). Furthermore, the entity configuration profile 220 can include data processing operations such as computing processes or actions corresponding to execution of processing instructions to process, collect, access, store, retrieve, modify, or delete target data. For example, data processing operations can correspond to processing instructions for data collection, data storage, data analysis, data integration, data security, data privacy, or data privacy operations.

The data configuration management system 104 utilizes a framework change processor 230 to determine a configuration gap indicating that one or more attributes of the entity, data assets associated with the entity, or data processing operations associated with the entity are not in compliance with the system requirements framework change 210. In particular, the data configuration management system uses the framework change processor 230 to determine a gap rules set including one or more gap rules associated with the system requirements framework to identify one or more desired state instructions in response to determining the configuration gap. For example, the framework change processor can utilize a fine-tuned large language model 250 to generate desired state instructions indicating a desired state of the configuration profile according to the system requirements framework change 210 that place the configuration profile in compliance. The framework change processor 230 provides the desired state instructions to the regulatory change enactment engine 240.

Moreover, the data configuration management system 104 utilizes the regulatory change enactment engine 240 to generate tasks for modifying attributes of the configuration profile of the entity according to the desired state instructions. For example, the regulatory change enactment engine utilizes the fine-tuned large language model 250 to generate tasks for applying modifications to data assets or data processing operations of the entity according to the desired state instructions. To illustrate, the regulatory change enactment engine 240 generates the tasks based on a comparison of a desired state of the entity configuration profile 220 of the entity relative to a current state of the entity configuration profile 220. In some aspects, the regulatory change enactment engine 240 generates tasks associated with generating a risk profile, a control recommendation, or a task recommendation associated with correcting a configuration gap caused by one or more changes to digital data requirements of a system requirements framework. Additionally, in some aspects, the regulatory change enactment engine 240 generates tasks to implement (e.g., automatically or via one or more client devices) control actions for installing one or more controls associated with handling data in view of the changes to the system requirements framework.

As shown, the data configuration management system 104 implements, or causes a computing device to implement, computing system modifications 260 based on the generated tasks. For instance, the data configuration management system 104 implements one or more control actions to cause computing devices to install one or more controls in connection with the data assets or the data processing operations and the digital data requirements. In one or more aspects, the data configuration management system 104 provides tools for a user device to implement computing system modifications 260 utilizing one or more controls in connection with applying the tasks to manage the attributes of the entity. In certain aspects, the data configuration management system 104 generates and displays tasks via a graphical user interface of a computing device for applying computing system modifications 260 to the data assets and/or data processing operations of the entity to address configuration gaps for complying with the system requirements framework.

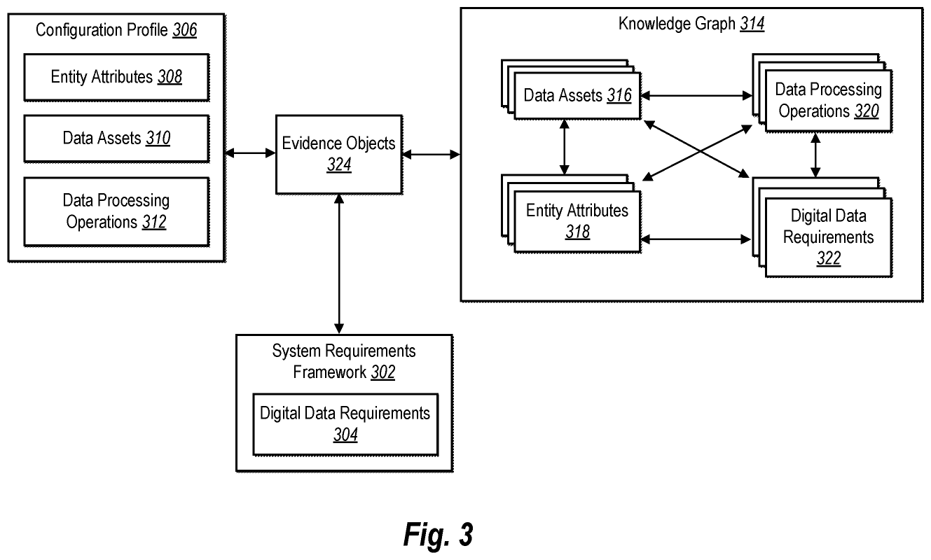

As mentioned, the data configuration management system 104 generates a mapping between a configuration profile of data assets and data processing operations associated with an entity and a knowledge graph that delineates relationships between entities and digital data requirements of a system requirements framework. FIG. 3 illustrates an example of mapping relationships between attribute values corresponding to a configuration profile and a knowledge graph in accordance with one or more aspects.

To illustrate, the data configuration management system 104 can integrate with computing hardware of a third-party system to communicate with computing systems associated with (or otherwise including information about) a system requirements framework to detect changes to a digital data requirement for handling specific data types. The data configuration management system 104 can utilize such information to determine and recommend changes to digital content to ensure that the digital content complies with the system requirements framework. As an example, the data configuration management system 104 can automatically detect whether a particular entity associated with a specific data asset or data processing operation is utilizing the correct encryption standard for handling a specific data type (e.g., based on a change to a digital data requirement) and determine a modification to the digital content for the entity that does not have the correct encryption that would address such issues. The data configuration management system 104 can thus automatically detect the need for modifications to specific digital content for the entity and assist in addressing any non-compliance issues such as, for example, automated modification of one or more digital assets to implement the correct encryption according to a specific control.

In some aspects, the data configuration management system 104 can identify if a system requirements framework 302 is applicable to operations of a given entity based on, for example, data types handled by computing systems or computing functions operated by the entity. To illustrate, to determine whether the digital content of an entity complies with the system requirements framework 302, the compliance management computing system generates mappings (e.g., via corresponding nodes and edges) between various entity attributes, data asset attributes, data processing operation attributes, and digital data requirements of one or more system requirements frameworks within a knowledge graph 314. Further, based on the mappings in the knowledge graph 314, the data configuration management system 104 determines whether the entity attributes 308 and the attributes of the data assets 310 and the data processing operations 312 of the entity correspond to the digital data requirements 304 of the system requirements framework 302.

In response to determining that the system requirements framework 302 is applicable to the entity based on the knowledge graph 314, the data configuration management system 104 can determine that one or more changes to the digital data requirements 304 of the system requirements framework 302 are applicable to the entity. In particular, the data configuration management system 104 can determine whether the corresponding data objects violate a system requirements framework according to the changed digital data requirements. As previously mentioned, the digital data requirements 304 of the system requirements framework 302 can indicate whether operations of an entity conform with various requirements of handling certain types of data (e.g., in accordance with a regulatory framework, a framework recommending best practices, a framework used for certification with privacy or security requirements, etc.).

The system requirements framework 302 can include internal practices of an entity or external standards imposed by regulatory authorities, such as the International Organization for Standardization (ISO). For example, the data configuration management system 104 accesses a digital content items from a digital data repository and extracts the changed digital data requirements in response to detecting the change to the digital representation of the system requirements framework 302. As an example, the system requirements framework 302 can indicate the retention protocols for a type of data (e.g., retention duration, storage requirements) and indicate how to apply the system requirements framework to a particular digital content item. This could involve setting retention periods for the digital content item or determining encryption methods for data security within a particular computing environment. The system requirements framework 302 can include all system requirements frameworks associated with the entity. In connection with identifying the system requirements framework 302 for the entity, the data configuration management system 104 also determines the corresponding controls and control actions for the system requirements framework 302.

The below description provides a more detailed example of the data configuration management system 104 detecting changes to a system requirements framework that impact an entity. For example, the data configuration management system 104 can identify the system requirements framework 302 that is applicable to operations of a given entity based on, for example, entity attributes 308, data assets 310 handled by the entity, and/or the data processing operations 312 of the entity as represented by the configuration profile 306. For example, the data configuration management system 104 determines a mapping that reflects a relationship between entity attributes 308, attributes of one or more of the data assets 310 or one or more of the data processing operations 312 associated with the entity, and the digital data requirements for handling the specific data types. Accordingly, a digital representation of the system requirements framework 302 includes one or more files indicating required controls for complying with the digital data requirements 304 of the system requirements framework 302.

Furthermore, the data configuration management system 104 utilizes a knowledge graph 314 that includes a representation (e.g., via nodes and edges) of the relationships between data assets 316, entity attributes 318, data processing operations 320, and the digital data requirements 322 of the system requirements framework. Specifically, the knowledge graph stores various characteristics that can be used for determining relationships between the between data assets 316, entity attributes 318, data processing operations 320, and the digital data requirements 322 of the system requirements framework. To illustrate, the knowledge graph 314 includes implementation details associated with various controls and operational details that the data configuration management system 104 utilizes in determining the relationships between the between data assets 316, entity attributes 318, data processing operations 320, and the digital data requirements 322 of the system requirements framework. As an example, an attribute of a data assets 316, such as a data object representing a database, may include the type of encryption used for encrypting sensitive data stored in the database. As another example, an attribute of a data processing operation 320, such as processing access to sensitive data, may include a type of access control for granting access to the sensitive data.

As shown, the data configuration management system 104 utilizes one or more of the evidence objects 324 to track the mapping between the configuration profile 306 and the knowledge graph 314. Based on the mapping, the data configuration management system 104 determines whether a change to the digital representation of the system requirements framework 302 is associated with the entity and generates one or more of the evidence objects 324. In particular, the data configuration management system 104 utilizes a large language model to determine if the current state of the configuration profile 306 (e.g., the entity attributes 308, the data assets 310, and/or the data processing operations 312) is in compliance with the system requirements framework 302. In one or more aspects, the data configuration management system 104 utilizes one or more of the evidence objects 324 to collect evidence associated with whether the desired state of the configuration profile 306 is in compliance according to updates to the system requirements framework 302.

The data configuration management system 104 can link or otherwise associate the evidence objects 324 with one or more controls associated with the digital data requirements 304. In one or more aspects, the evidence objects 324 include a data object representing, or otherwise indicating, digital data for proving or verifying that a particular control has been installed/implemented. In particular, the data configuration management system 104 utilizes one or more of the evidence objects 324 to track the collection of evidence that one or more controls associated with the digital data requirements 304 of the system requirements framework 302 have been implemented by an entity. In some aspects, determining an evidence object includes instantiating or otherwise creating the evidence objects 324. To illustrate, the data configuration management system 104 determines whether one or more files are stored in a digital data repository to indicate installation of a control in connection with one or more data assets or data processing operations. Furthermore, the data configuration management system 104 can store information (e.g., as or with an evidence object) indicating that a particular control has been installed.

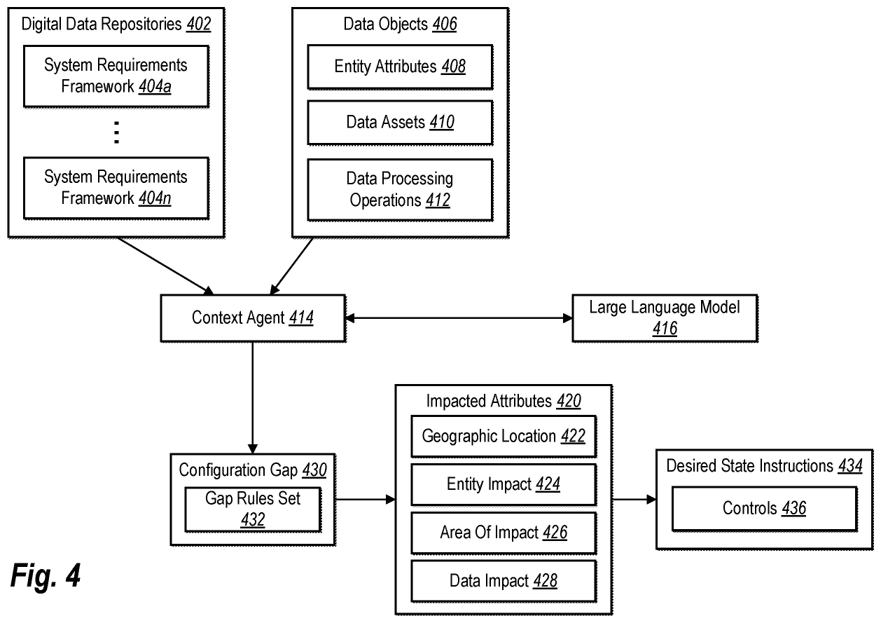

As mentioned, the data configuration management system 104 utilizes a large language model to manage compliance of computing systems with system requirements frameworks (e.g., internal or external policies, regulations, or standards) that indicate specific requirements on how the computing systems should handle certain data types. The data configuration management system 104 can utilize a large language model to generate desired state instructions indicating a desired state of the configuration profile according to the updated system requirements framework (e.g., one or more attribute values of digital assets or digital processing operations) that place the configuration profile in compliance. FIG. 4 illustrates an example of the compliance management computing system determining desired state instructions utilizing a large language model in accordance with one or more aspects.

As mentioned, the data configuration management system 104 extracts the changed digital data requirements in response to detecting the change to the digital representation of one or more of the system requirements frameworks 404a-404n. The system requirements frameworks 404a-404n are a digital representation of the requirements frameworks used to assess operations of an entity (e.g., a regulatory framework, a framework recommending best practices, a framework used for certification with privacy or security requirements, etc.). Each system requirements framework 302 includes controls indicating requirements for complying with the system requirements frameworks 404a-404n. Accordingly, a digital representation of a particular framework includes one or more files indicating required controls for complying with the framework.

The data configuration management system 104 accesses digital items from one or more of the digital data repositories 402 based on an update to one or more of the system requirements frameworks 404a-404n. For example, in one or more aspects, the data configuration management system 104 can receive a notification of a change to one or more of the system requirements frameworks 404a-404n from an automated digital platform dedicated to tracking legislative and regulatory developments across various jurisdictions, sectors, and domains. In certain aspects, the data configuration management system 104 can receive a notification of a change to one or more of the system requirements frameworks 404a-404n from a third-party system by analyzing RSS feeds, regulatory databases, legal updates, and/or industry-specific news feeds (e.g., using APIs and/or text analysis applications).

As shown, the data configuration management system 104 accesses data objects 406 including one or more of the entity attributes 408, data assets 410, and/or data processing operations 412 associated with an entity based on changes to the system requirements frameworks 404a-404n. As described in relation to FIG. 3, the data configuration management system 104 determines a mapping between a configuration profile of an entity and one or more of the system requirements frameworks 404a-404n to determine if the data objects 406 (e.g., entity attributes 408, data assets 410, and/or data processing operations 412) are impacted by a change to the digital data requirements (e.g., impacted attributes 420). Based on whether the data objects 406 are impacted by a change to the digital data requirements, the data configuration management system 104 utilizes a context agent 414 (e.g., application programming interface) to interface with a large language model 416 to determine the impacted attributes 420 of the entity.

In some aspects, the data configuration management system 104 determines the impacted attributes 420 representative of a geographic location 422, an entity impact 424, an area of impact 426, and/or a data impact 428. For example, the data configuration management system 104 can identify the impacted attributes 420 representative of the geographic location 422 including a digital representation of the physical or virtual geographic location of where data is stored, processed, or transmitted. The geographic location 422 can account for how the system requirements frameworks 404a-404n impact different locations include varying legal and regulatory requirements that incorporate different data handling requirements. For example, data stored in the European Union must comply with the General Data Protection Regulation (GDPR), while data in the United States may be subject to different laws like the California Consumer Privacy Act (CCPA). In addition, in one or more aspects, the data configuration management system 104 determines additional impacted attributes such as, but not limited to, a regulatory impact, an operational impact, an environmental impact, a duration impact, a severity impact, a time impact, a technological impact, and/or other impacts.

As another example, the data configuration management system 104 can identify a configuration gap representative of the entity impact 424. The entity impact 424 can be include a digital representation of how the system requirements frameworks 404a-404n impact the specific entity, which could include an impact on the entity, a system within the entity, or a particular data process. For instance, the entity impact 424 can include a digital representation of a requirement by the system requirements frameworks 404a-404n for the entity to maintain certain levels of data security to protect sensitive customer information.

As another example, the data configuration management system 104 can identify the impacted attributes 420 of the area of impact 426. The area of impact 426 can include digital representations of specific domains, industries, or areas within an entity that are impacted by the system requirements frameworks 404a-404n. For example, the system requirements frameworks 404a-404n may impact the HR department requirements within an entity that have stringent data privacy requirements for employee data or impact the marketing department within the entity that requires specific data accuracy and segmentation.

As another example, the data configuration management system 104 can identify the impacted attributes 420 representative of the data impact 428. The data impact 428 can include consequences to the entity data due to the system requirements frameworks 404a-404n. The data impact 428 can encompass an impact of the system requirements frameworks 404a-404n related to data quality, security, accessibility, and/or compliance such as data encryption practices or data access controls.

As further shown in FIG. 4, the data configuration management system 104 utilizes the large language model 416 to determine a configuration gap 430 indicating that one or more of the impacted attributes 420 are not in compliance with the updated system requirements framework. To illustrate, in certain aspects, the data configuration management system 104 retrieves the current state of the data objects 406 from the digital data repositories 402. The data configuration management system 104 utilizes the context agent 414 to format a request to the large language model 416 that includes the data objects 406 and the details of the system requirements frameworks 404a-404n (e.g., JSON format). In some aspects, the data configuration management system 104 utilizes the context agent 414 to generate one or more prompts for the large language model 416 including details from the relevant data objects and system requirements framework(s).

In response to receiving the request, the large language model 416 (trained on a corpus of technical documentation and compliance data to understand the context and significance of the system requirements frameworks 404a-404n) performs a semantic analysis on both the data objects 406 and the system requirements frameworks 404a-404n. As shown, the data configuration management system 104 determines the configuration gap 430 corresponding to a gap rules set 432 including one or more gap rules for identifying configuration gaps that should be addressed for an entity to be compliant with a corresponding system requirements framework associated with the system requirements frameworks 404a-404n.

In one or more aspects, the data configuration management system 104 utilizes the gap rules set 432 to determine whether the impacted attributes 420 indicate compliance with the system requirements frameworks 404a-404n. To illustrate, the data configuration management system 104 identifies one or more of the impacted attributes 420 associated with the data objects 406 and determines each of the attribute values corresponding to the impacted attributes 420. The data configuration management system 104 applies the gap rules set 432 by determining whether each attribute of the impacted attributes 420 is impacted by the changes to the system requirements frameworks 404a-404n based on the gap rules set 432. In various examples, an attribute value for the impacted attributes 420 may be outside an acceptable threshold, may be included in a set of acceptable threshold values, or may specify the presence of a certain condition (e.g., a geographic location 422 attribute value indicating a location to which certain framework are applicable, an area of impact 426 attribute value indicating a type of business to which certain framework are applicable, etc.). Accordingly, the data configuration management system 104 utilizes the large language model 416 to determine the appropriate attribute values for the corresponding impacted attributes 420 or other type of function or infrastructure in view of the gap rules set 432.

According to one or more aspects, the data configuration management system 104 utilizes an iterative process to determine whether there are more of the data objects 406 to be processed. In response to determining that there are more of the data objects 406 to be processed, the data configuration management system 104 selects another data object of the data objects 406. The data configuration management system 104 proceeds with identifying the attribute values of the new data object of the data objects 406 and applies the gap rules set 432 to the attribute values of the new data object of the data objects 406 to determine new impacted attributes 420.

In some aspects, the data configuration management system 104 can utilize the large language model 416 to generate desired state instructions indicating a desired state of the configuration profile according to the system requirements frameworks 404a-404n. In particular, the data configuration management system 104 utilizes the configuration gap 430 generated utilizing the large language model 416 to generate the desired state instructions 434 indicating an impact of a change to the digital representation of the system requirements frameworks 404a-404n relative to the configuration profile. For example, the data configuration management system 104 utilizes the gap rules set 432 (via the large language model 416) to determine the configuration gap 430 and generate desired state instructions 434 in connection with the data objects 406 according to the system requirements frameworks 404a-404n. To illustrate, the data configuration management system 104 determines the desired state instructions 434 by utilizing the context agent 414 associated with the large language model 416 to determine the configuration gap 430 in response to applying one or more gap rules to the impacted attributes 420 (and/or corresponding to the entity attributes 408, the data assets 410, and/or the data processing operations 412). Additionally, in response to determining the configuration gap 430, the data configuration management system 104 generates the desired state instructions 434 associated with a modification of one or more of the controls 436. The data configuration management system 104 generates the desired state instructions by comparing the digital representation of the system requirements frameworks 404a-404n to the impacted attributes 420 to generate a configuration gap 430 representative of the geographic location 422, the entity impact 424, the area of impact 426, and/or the data impact 428.

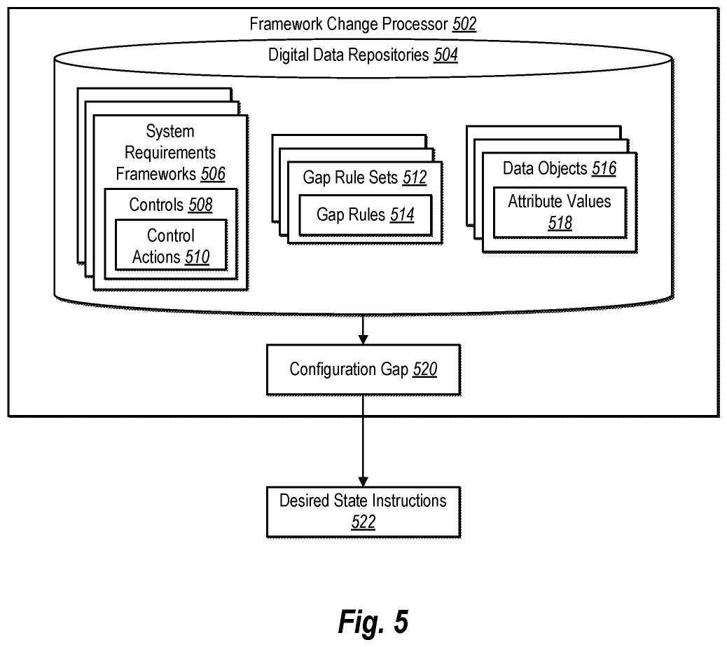

In one or more aspects, the data configuration management system 104 utilizes a framework change processor to determine the desired state instructions. FIG. 5 illustrates an example of the data configuration management system 104 utilizing a framework change processor 502 to determine desired state instructions 522 to implement controls 508 to correct a configuration gap 520 based on a gap rules set 512 in accordance with one or more aspects.

As illustrated in FIG. 5, the framework change processor 502 accesses digital data repositories 504 to determine system requirements frameworks 506, gap rule sets 512, and data objects 516. In particular, the digital data repositories 504 can include a plurality of digital data repositories and include data associated with one or more entities. Alternatively, one or more of the digital data repositories 504 can store different data types within each digital data repository. Accordingly, a single digital data repository may store data associated with a plurality of different entities. Furthermore, the digital data repositories 504 may store data for an entity across a plurality of digital data repositories. In one or more aspects, the digital data repositories 504 store data associated with the framework change processor 502. In the example depicted in FIG. 5, the digital data repositories 504 store the system requirements frameworks 506 (e.g., digital representations of the system requirements frameworks 506) that include associated controls 508 and control actions 510, the gap rule sets 512 and associated gap rules 514, and data objects 516 that include associated attribute values 518.

In one or more aspects, the digital data repositories 504 include the gap rule sets 512 and the associated gap rules 514. In particular, the gap rule sets 512 include gap rules 514 for determining whether a configuration gap 520 exists relative to a particular system requirement framework of the system requirements frameworks 506. For example, the framework change processor 502 determines the gap rule sets 512 based on the control actions 510 (and the corresponding controls 508) for the system requirements frameworks 506. The data configuration management system 104 determines the gap rules set 512 for identifying a configuration gap 520 that should be addressed for an entity to be compliant with one or more of the system requirements frameworks 506.

In some aspects, configuration gap 520 includes indications of control actions 510 for implementing controls 508 to comply with the corresponding system requirements frameworks 506. Specifically, a configuration gap 520 indicates that the framework change processor 502 was unable to determine that one or more of the controls 508 of the system requirements frameworks 506 has been implemented. In one example, the configuration gap 520 indicates that the framework change processor 502 cannot identify sufficient evidence of one or more of the controls 508 being installed in relation to the data objects 516 (e.g., in relation to a corresponding data asset or data processing operation) according to a particular gap rule of the gap rules 514 (e.g., an attribute value was not acceptable or an attribute value was missing).

For instance, the data configuration management system 104 can determine the gap rules set 514 based on the control actions 510. To illustrate, the framework change processor 502 determines gap rules 514 that are related to control actions 510 to verify that corresponding controls 508 are installed. In one or more aspects, the data configuration management system 104 determines the gap rules set 512 for the digital data repositories 504 based on the control actions 510 and one or more links between the control actions 510 and gap rules 514 stored in the digital data repositories 504. In additional aspects, the framework change processor 502 determines one or more of the gap rules 514 based on user input via a client device.

For example, the framework change processor 502 can determine compliance by applying the gap rules set 512 to the attribute values 518 for the corresponding data objects 516. To illustrate, the framework change processor 502 compares the attribute values 518 to acceptable/relevant attribute values indicated by the gap rules set 512 to determine whether each attribute values 518 (and/or corresponding to the data objects 516) has installed a particular control of the controls 508 corresponding to the system requirements frameworks 506. The framework change processor 502 can also provide the identified configuration gap 520 for display via a graphical user interface of a client device. To illustrate, the framework change processor 502 determines the gap rules 514 indicating that a configuration gap 520 exists if an entity-which has a website for collecting credit card information-has not implemented a firewall for the website according to a corresponding control action for the data objects 516.

In particular, the data configuration management system 104 utilizes the configuration gap 520 to generate the desired state instructions 522 indicating a change to the digital representation of the system requirements frameworks 506 relative to the configuration profile. For example, the framework change processor utilizes the gap rules set 512 to determine the configuration gap 520 and generate desired state instructions 522 in connection with the data objects 516 according to the system requirements frameworks 506. To illustrate, the framework change processor 502 determines the desired state instructions 522 by applying one or more of the gap rules 514 to the data objects 516. In response to determining the configuration gap 520, the framework change processor generates the desired state instructions 522 associated with a modification of one or more of the controls 508. As a simplified example, one or more of the gap rules 514 can indicate that if the data objects 516 for a data asset have a “retention” attribute with a value indicating that the data asset can be retained for a specific timeframe, the desired state instructions 522 address the configuration gap 520 by implementing controls for compliance with jurisdiction-specific data retention practices.

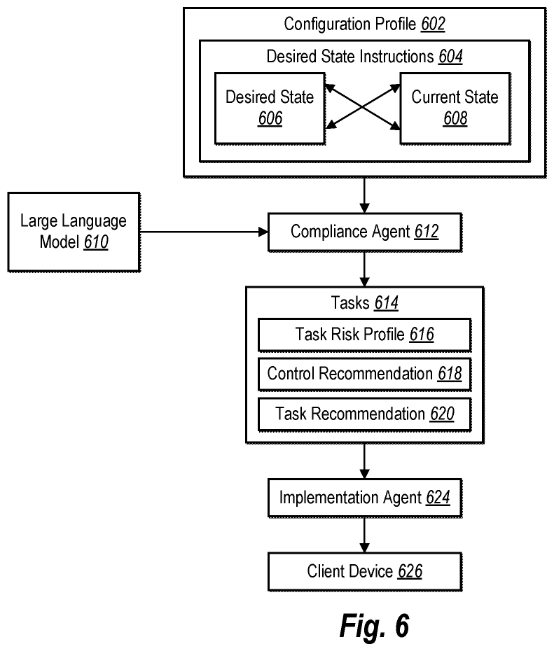

According to one or more aspects, the data configuration management system utilizes a regulatory change enactment engine to generate tasks for modifying attributes of the configuration profile of the entity according to the desired state instructions. FIG. 6 illustrates an example of the data configuration management system determining and providing tasks for implementing changes to a configuration profile of an entity to a client device in accordance with one or more aspects.

As shown, in certain aspects, the regulatory change enactment engine utilizes a large language model 610 to generate tasks 614 for applying modifications to data assets or data processing operations of the entity according to the desired state instructions 604. In certain aspects, the regulatory change enactment engine receives the desired state instructions 604 from the framework change processor as described in relation to FIGS. 4-5.

In one or more aspects, the regulatory change enactment engine utilizes a large language model 610 to perform a comparison between the desired state 606 of the configuration profile 602 and the current state 608 of the configuration profile 602. As shown, the regulatory change enactment engine utilizes the compliance agent 612 (e.g., application programming interface) to communicate with the large language model 610 to determine tasks 614 in response to receiving the desired state instructions 604. In particular, the large language model 610 utilizes the compliance agent 612 to perform a comparison between the desired state 606 (based on the desired state instructions 604) and the current state 608. In response to the large language model 610 identifying discrepancies between the desired state 606 and the current state 608, the large language model 610 generates tasks 614 that, when executed, adjust the current state 608 to the desired state 606.

In certain aspects, the tasks 614 include generating a task risk profile 616, a control recommendation 618, and/or a task recommendation 620. For example, the tasks 614 can indicate operations to implement controls required to correct the configuration gap caused by changes to the digital data requirements of a system requirements framework. To illustrate, the task risk profile 616 can include an analysis of various risks to the data configuration management system 104 such as security vulnerabilities, compliance shortfalls, or operational inefficiencies. In addition, the task risk profile 616 can include a categorization (and indication) of the various risks according to a severity metric which indicates a category of risk such as on a scale from a low risk vulnerability to a high risk vulnerability. For example, the task risk profile 616 can include an indication of the various controls for correcting the configuration gap that are based on the category of risk, wherein the task risk profile 616 includes the indication of different controls for the different categories of risk.

In some aspects, the task risk profile 616 can indicate a low risk security vulnerability and one or more controls associated with correcting the configuration gap (e.g., in a less aggressive alternative) or can indicate a high risk security vulnerability and indicate one or more controls associated with correcting the configuration gap (e.g., in a more aggressive alternative). To illustrate, the task risk profile 616 can identify the desired state instructions 604 indicating a change in the way “cookie banners” must be displayed within digital content and indicate a control including a low priority notification to the entity. In another example, the task risk profile 616 can identify the desired state instructions 604 indicating a change in the way encryption of data for banking records is accomplished and indicate a control that incorporates a high priority update to the data for the banking records.

In one or more aspects, the tasks 614 include the control recommendation 618, which includes a recommendation of one or more controls for adjusting current state 608 to the desired state 606. Specifically, the regulatory change enactment engine analyzes the current state 608 and the desired state 606 of the configuration profile and determines the control recommendation 618 indicating a selection and/or recommendation of one or more controls to adjust the current state 608 to the desired state 606. For example, the control recommendation 618 can include the selection and/or recommendation of controls for correcting the configuration gap that based on the task risk profile 616 (e.g., a control recommendation).

In some aspects, the control recommendation 618 can include selecting and/or recommending different one or more controls for different categories of risk. To illustrate, the control recommendation 618 can recommend one or more controls for handling a change in the way “cookie banners” must be displayed within digital content that include a notification to the entity. In another example, the control recommendation 618 can recommend one or more controls for handling a change in the way encryption of data for banking records is accomplished that incorporate an immediate update to the data for the banking records.

In one or more aspects, the tasks 614 include the task recommendation 620, which includes the selection of one or more controls for adjusting current state 608 to the desired state 606. For example, based on the control recommendation 618, the regulatory change enactment engine selects one or more controls to adjust the current state 608 to the desired state 606 to comply with the corresponding system requirements framework. In one or more aspects, the task recommendation 620 can include selecting one or more controls for handling specific data types that entities are required to follow in connection with a regulation governing security or privacy. To illustrate, the task recommendation 620 can include generating duplicate controls to change the way encryption of data for banking records is accomplished to incorporate an update to the data for the banking records. In certain aspects, the task recommendation 620 automates the performance of control actions associated with the one or more controls to adjust the current state 608 to the desired state 606. In certain aspects, the task recommendation 620 includes computing instructions to perform control actions to create a duplicate version of the controls based on adjusting the current state 608 to the desired state 606 to comply with the corresponding system requirements framework.

As shown in FIG. 6, the regulatory change enactment engine can utilize an implementation agent 624 to implement the tasks 614 on the client device 626. In connection with determining the tasks 614 as indicated by the task risk profile 616, the control recommendation 618, and/or the task recommendation 620, the regulatory change enactment engine determines controls required to comply with the system requirements frameworks. More specifically, the regulatory change enactment engine determines control actions for installing the appropriate controls for each of the system requirements frameworks based on the tasks 614.

As an example, the data configuration management system 104 determines that the desired state instructions 604 correspond to a change in a system requirements framework that covers handling of credit card data by entities involved in processing credit card transactions. In particular, the data configuration management system 104 determines that the tasks 614 define a plurality of controls required to be installed for compliance with the standard. To illustrate, the data configuration management system 104 determines that one such control is establishing firewalls and web filtering to protect cardholder data. For example, a control action for establishing firewalls includes fully documenting and implementing key-management processes and procedures for cryptographic keys used for encryption of cardholder data. Thus, according to one or more aspects, the implementation agent 624 implements the control actions associated with the tasks 614 for handling the target data objects of the system requirements framework.

In certain aspects, the data configuration management system 104 can generate an implementation of a staging environment based on the control recommendation 618. For example, the data configuration management system 104 determines a control establishing a notification period for a data breach of 70 days instead of 90 days based on the control recommendation 618. The data configuration management system 104 can generate a staging environment implementing the control actions for the control and modifying the data assets and data processing operations of the entity to reflect the change in the notification period. The data configuration management system 104 can provide the staging environment, or access to the staging environment, to an administrator client device for purposes of evaluation of the changes. In some aspects, the data configuration management system 104 provides a notification to the client device 626 for verifying or approving the control actions for the control within the staging environment.

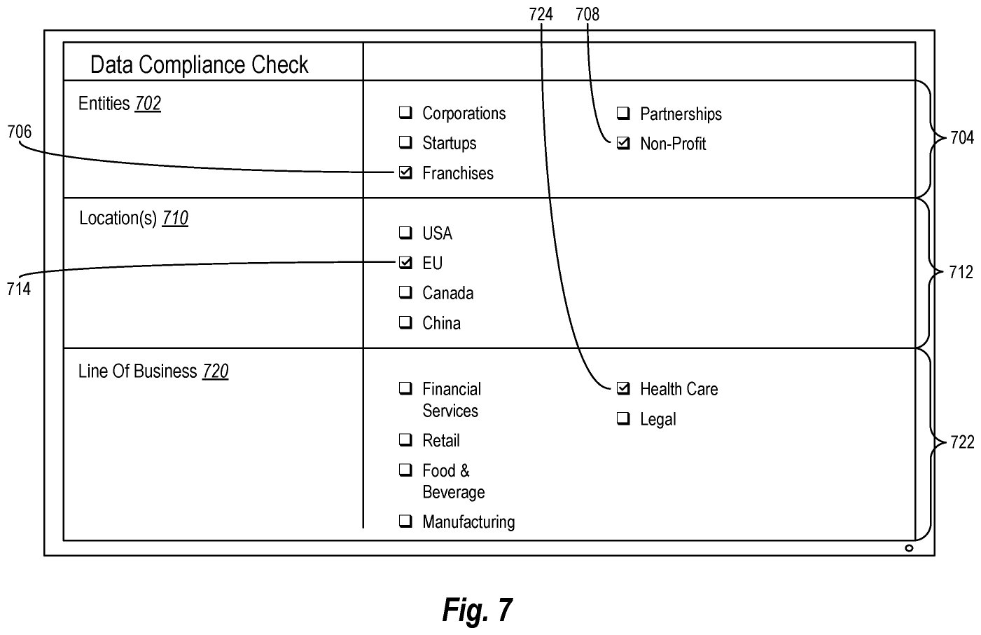

As mentioned, the data configuration management system 104 can provide automated tools or graphical user interface tools to easily modify digital content according to the tasks and based on a change to a system requirements framework including the digital data requirements for handling specific data types. FIG. 7 illustrates an example of a graphical user interface for initiating a compliance check for an entity in accordance with one or more aspects. In particular, FIG. 7 illustrates a graphical user interface for establishing various attributes of an entity in connection with the compliance check.

For example, the data configuration management system 104 provides, for display on an administrator client device via a client application, tools for performing a data compliance check for one or more entities, locations, and/or line of business. For example, FIG. 7 illustrates an example graphical user interface including tools to indicate one or more of the entities 702. For example, the client device displays a list of selectable entities 704 that includes types of entities that are (or may be) affected by changes to the system requirements frameworks. As shown, the list of selectable entities 704 can include corporations, startups, franchises, partnerships, or non-profit organizations. In certain aspects, the list of selectable entities 704 can include specific entities related to the data configuration management system 104 (e.g., specific names of organizations).

In addition, FIG. 7 illustrates the example graphical user interface includes tools to indicate locations 710 in which an entity can operate. To illustrate, the list of selectable locations 712 includes countries from which a user operating the client device can select. Although FIG. 7 illustrates that the list of selectable locations 712 includes countries, the client device can alternatively display more granular locations, such as countries within a particular continent, states/provinces within a particular country, or other geographic areas.

As also shown, FIG. 7 illustrates the example graphical user interface includes tools to indicate a line of business 720 in which an entity can operate. As shown, the data configuration management system 104 provides options for selecting a specific line of business from within a selectable list of lines of business 722, such as fields of practice/operation such as financial services, retail, food and beverage, manufacturing, health care, and/or legal. For example, the data configuration management system 104 can detect the selection of one or more of the entities 702, one or more of the locations 710, and one or more of the line of business 720. For example, the data configuration management system 104 can detect the selection of the “Franchises” entity 706. As another example, the data configuration management system 104 can detect the selection of a combination of the “Franchises” entity 706 and a “Non-Profit” entity 708. As another example, the data configuration management system 104 can detect the selection of the “Franchises” entity 706, the “EU” location 714, and the “Health Care” line of business 724.

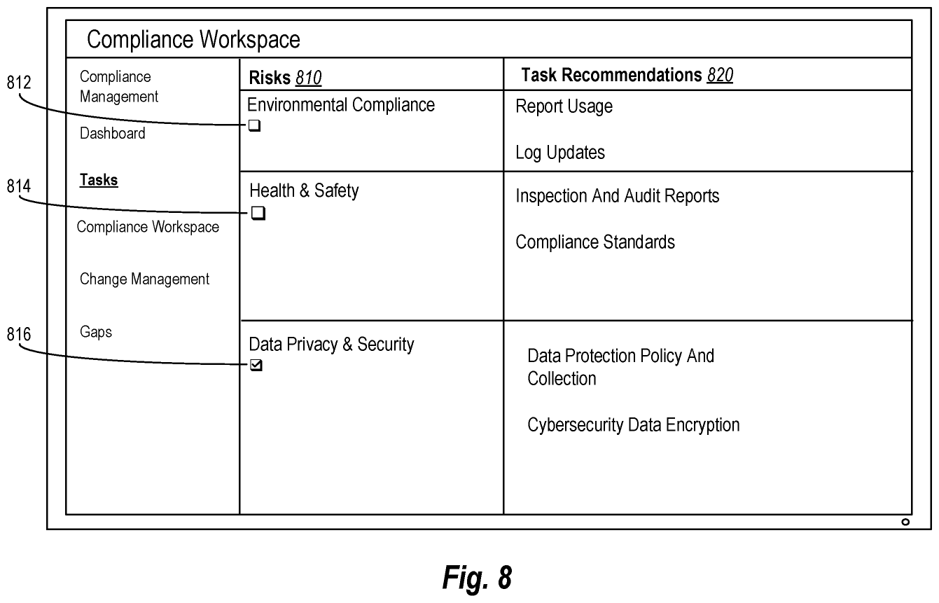

In connection with selecting one or more of the entities 702, the locations 710, and the line of business 720, the data configuration management system 104 can also provide tools for selecting tasks to correct one or more risks (e.g., configuration gaps) caused by one or more changes to the digital data requirements of the system requirements framework. FIG. 8 illustrates a graphical user interface within an administrator client device via the client application for selecting one or more risks to which an entity may be subject based on the types of data the entity handles.

To illustrate, the data configuration management system 104 can detect the selected entity 706, the selected location 714, and/or the selected line of business 724 (e.g., based on a selection via the graphical user interface of FIG. 7). In response to determining the selected entity, the selected location, and/or the selected line of business, the data configuration management system 104 provides, for display via the graphical user interface, a list of the risks 810. The risks 810 include risks to the entity based on one or more of the selected entities, locations, and line of business based on changes to system requirements frameworks. Additionally, the data configuration management system 104 can determine the risks 810 in response to accessing data objects representing the entity's data assets and/or data processing operations, as previously described.

In one or more aspects, the data configuration management system 104 can categorize the risks 810. As an illustrated example, the data configuration management system 104 can categorize the risks into an environmental compliance risk 812, a health & safety risk 814, and a data privacy & security risk 816. Additionally, the risks 810 are not limited to the categories of risk displayed in FIG. 8, and the data configuration management system 104 can categorize the risks 810 in other ways via the graphical user interface.

Furthermore, as illustrated in FIG. 8, the data configuration management system 104 can determine and provide one or more task recommendations 820 associated with the risks 810 for display at the administrator client device. To illustrate, the data configuration management system 104 can provide the task recommendations 820 for the environmental compliance risk 812 including recommended tasks to report usage (e.g., reporting usage of various resources to regulatory bodies) and log updates (e.g., logging updates for changes in policies or procedures). As another example, the data configuration management system 104 can provide task recommendations 820 for the health & safety risk 814 related to inspection and audit reports (e.g., evaluation of an organizations adherence to required protocols) and compliance standards (e.g., updating compliance standards to comply with new requirements). As another example, the data configuration management system 104 can provide task recommendations 820 for the data privacy & security risk 816 related to data protection policy and collection (e.g., updating the rules and practices of safeguarding personal data) and cybersecurity data encryption (e.g., updating the data encryption requirements).

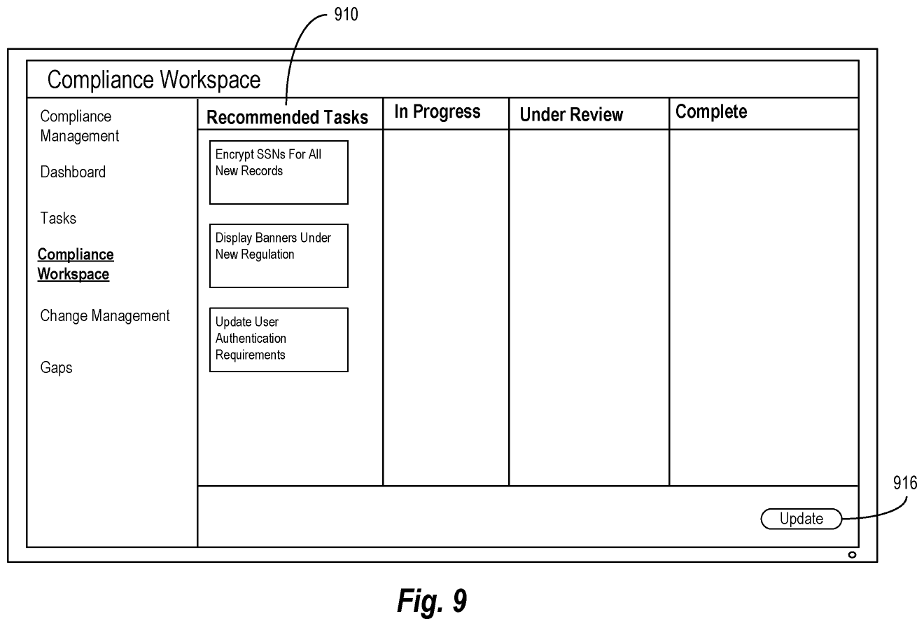

In at least some aspects, a given task recommendation is associated with a plurality of different possible system requirements frameworks that each correspond to a one or more controls for different data types and/or different approaches to meet the specific requirements of the system requirements frameworks and correct a configuration gap. FIG. 9 illustrates an example of a graphical user interface for providing recommended tasks to correct a configuration gap in accordance with one or more aspects.

For example, as shown in FIG. 9, based on a selection of the Data Privacy & Security risk 816 as illustrated in FIG. 8, the data configuration management system 104 causes the administrator client device to display a plurality of different tasks for an entity associated with changes to the system requirements frameworks. The data configuration management system 104 can provide the recommended tasks based on the associated entities, locations, line of business, jurisdictions, regulations, data objects associated with the entity, and/or a system requirements framework. In certain aspects, the data configuration management system 104 can determine the tasks corresponding to controls/control actions based on changes to the system requirements frameworks.

In one or more aspects, the data configuration management system 104 also provides tools for specifying tasks, (e.g., controls and/or control actions) associated with the selected system requirements frameworks. For example, a user of the administrator client device may determine that a particular task is not applicable to the entity. To illustrate, the user may determine that the entity does not maintain a public website for handling specific data types, so a control action involving a change to displaying banners based on a new regulation is not applicable to the entity. Accordingly, the user can interact with the client device to deselect the corresponding task. Similarly, the data configuration management system 104 can provide tools for adding additional tasks (e.g., from a different system requirements framework or a custom control).

In one or more aspects, the data configuration management system 104 provides one or more of the recommended tasks 910 corresponding to one or more controls for different data types to meet the specific requirements of the system requirements frameworks and correct a configuration gap. To illustrate, in response to detecting a selection of a data privacy & security risk 816 (as shown in reference to FIG. 8), the data configuration management system 104 can display recommended tasks 910 to remediate one or more configuration gaps based on changes to the system requirements frameworks. In one or more aspects, the administrator client device provides the update option 916 to initiate the application of the recommended tasks 910 and update the attributes of the configuration profile for an entity (e.g., by modifying corresponding data assets and/or data processing operations). In additional embodiments, the administrator client device also displays additional tools within the graphical user interface such as, but not limited to, a chat interface for communications between users involved in performing, verifying, or creating tasks.

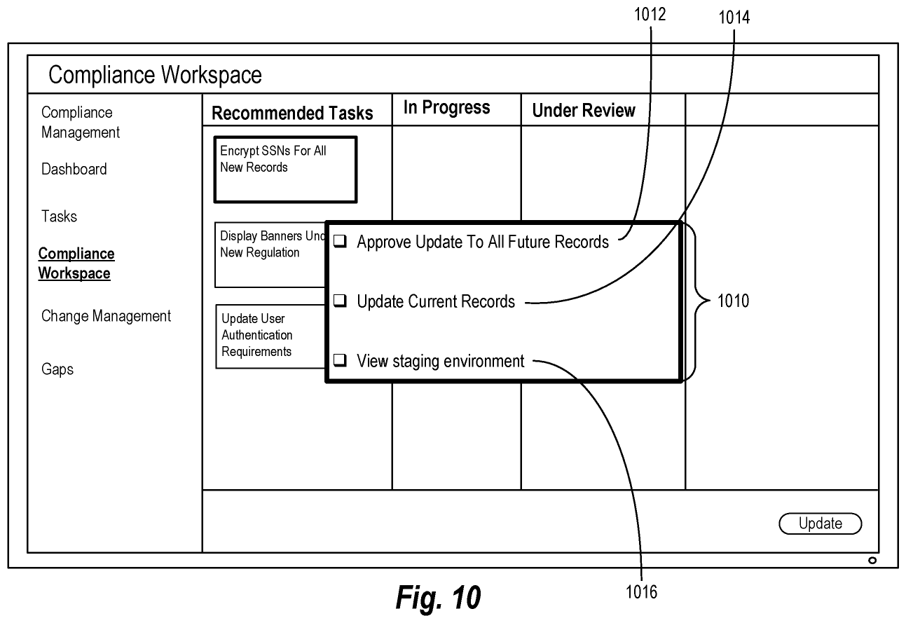

In certain aspects, based on an administrator client device interaction with the update option 916, the data configuration management system 104 provides an option on the administrator client device to confirm the implementation of the selected tasks after administrator client device review. FIG. 10 illustrates an example of a graphical user interface for requesting approval to implement changes to a configuration profile in accordance with one or more aspects. In this way, the data configuration management system 104 generates and displays tasks via a graphical user interface of the administrator client device for applying modifications to the data assets and/or data processing operations of the entity to address the configuration gaps for complying with the system requirements framework.

For example, based on an administrator client device interaction with the review interface 1010, the data configuration management system 104 implements, or causes a computing device to implement, control actions based on the recommended tasks. For example, the data configuration management system 104 implements one or more control actions to cause computing devices to install one or more controls in connection with the data assets or the data processing operations and the digital data requirements. To illustrate, the data configuration management system utilizes a software/hardware integration (e.g., via one or more API calls, database operations, or executables installed on the computing devices) to autonomously apply a specific control on a data asset or data type associated with the entity according to the digital data requirements.

To illustrate, in one or more aspects, the data configuration management system 104 provides an option to approve updates to all future records. For example, in connection with review item 1012, the data configuration management system 104 installs one or more controls to implement the selected tasks in connection with all future data assets for the associated configuration profile installed after the specified time. To illustrate, based on the administrator client device selection of review item 1012, the data configuration management system 104 installs one or more controls to implement a recommended task to “encrypt SSNs for all new records” for all future records associated with the selected entity.

In one or more aspects, in connection with review item 1014, the data configuration management system 104 updates the current data assets for an entity. For example, the data configuration management system 104 installs one or more controls to implement the selected tasks for the data assets for the associated configuration profile. To illustrate, based on the administrator client device selection of review item 1014, the data configuration management system 104 can install one or more controls to implement a recommended task to “Display Banners Under New Regulation” for all current records associated with the selected entity.

In certain aspects, in connection with review item 1016, the data configuration management system 104 provides a staging environment. For example, the data configuration management system 104 can generate a staging environment implementing the control actions for the control and modifying the data assets and data processing operations of the entity to reflect the changes for one or more of the recommended tasks. The staging environment can include a replica of the entity environment that simulates the data assets and data processing operations of the entity. The data configuration management system 104 provides the staging environment, or access to the staging environment, to an administrator client device to allow the user to evaluate the implementation of the recommended tasks. Based on an administrator client device interaction associated with the staging environment, the administrator client device applies one or more of the recommended tasks and updates the attributes of the configuration profile for an entity.

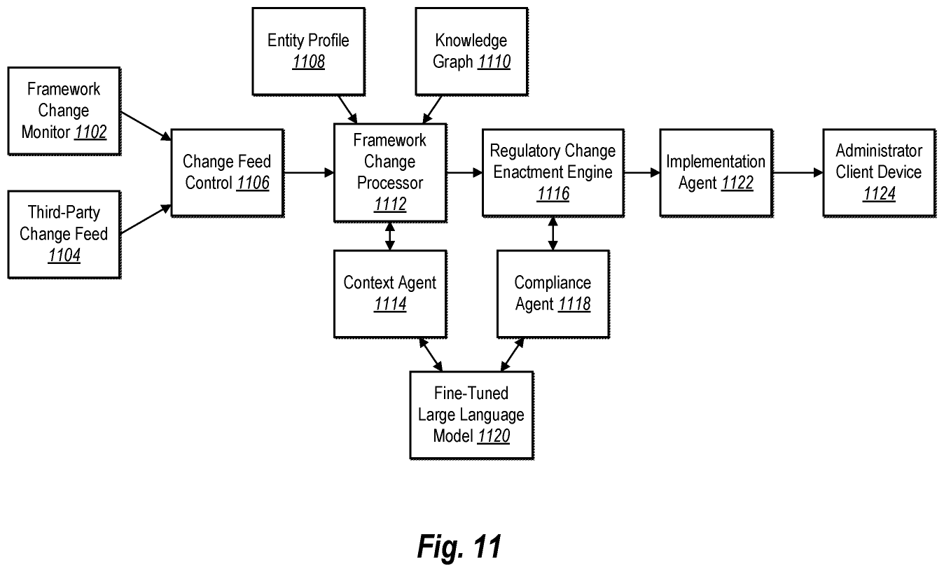

FIG. 11 illustrates an example implementation of the data configuration management system 104 in accordance with one or more aspects. Although FIG. 11 illustrates that the data configuration management system 104 utilizes a plurality of components within a cloud-based system and a plurality of components on a single entity device, the data configuration management system 104 can implement data configuration management for a plurality of devices.

As shown in FIG. 11, in one or more aspects, the data configuration management system 104 utilizes the change feed control 1106 to detect a change to a system requirements framework. In one or more aspects, the change feed control 1106 receives an indication of a change to a system requirements framework from the framework change monitor 1102. In one or more aspects, the change feed control 1106 receives an indication of a change to a system requirements framework from the third-party change feed 1104. In one or more aspects, the change feed control 1106 communicates with the framework change monitor 1102 and the third-party change feed 1104 utilizing one or more application programming interfaces and/or one or more natural language processing algorithms to determine the change to the system requirements framework. In some aspects, the change feed control 1106 can be implemented as described above with respect to FIGS. 2-3.

In one or more aspects, in response to detecting a change to a system requirements framework by the change feed control 1106, the data configuration management system 104 determines entities associated with the change to the system requirements framework. The framework change processor 1112 determines if the change to the system requirements framework is associated with an entity by comparing the entity profile 1108 (e.g., a configuration profile for an entity) with the knowledge graph 1110. Specifically, the data configuration management system 104 determines that one or more data assets or one or more data processing operations of the entity should comply with digital data requirements of the system requirements framework for handling specific data types based on the knowledge graph 1110. In some aspects, utilizing the knowledge graph 1110 can be implemented as described above with respect to FIG. 3.

In one or more aspects, in response to detecting a change to a system requirements framework by the change feed control 1106 and determining affected entities, the data configuration management system 104 initiates an analysis of the configuration gap by the framework change processor 1112. In particular, the data configuration management system 104 utilizes the framework change processor 1112 to determine desired state instructions associated with a configuration gap between assets of the entity and the system requirements framework. In response to the data configuration management system 104 determining a change to the system requirements is associated with an entity, the data configuration management system 104 utilizes the framework change processor 1112 in connection with a fine-tuned large language model 1120 and a context agent 1114 to determine a configuration gap between the entity profile 1108 the system requirements framework. For example, the context agent 1114 can include an application programming interface that receives the input data including the system requirements framework and the data assets and/or data processing operations of the entity of the entity to determine a configuration gap by communicating with the fine-tuned large language model 1120. In one or more aspects, the framework change processor 1112 provides desired state instructions to the regulatory change enactment engine 1116 reflecting the desired state of the data assets and/or the data processing operations of the entity for the entity in view of the configuration gap. In some aspects, the framework change processor 1112 can be implemented as described above with respect to FIGS. 4-5.

In certain aspects, the data configuration management system 104 utilizes the regulatory change enactment engine 1116 to generate tasks for modifying attributes of the configuration profile of the entity according to the desired state instructions. For example, the regulatory change enactment engine 1116 determines one or more controls associated with bringing the data assets and/or the data processing operations of the entity into compliance with the changes to the system requirements framework. As shown, the regulatory change enactment engine 1116 utilizes the fine-tuned large language model 1120 and the compliance agent 1118 to determine one or more controls associated with bringing the data assets and/or the data processing operations of the entity into compliance with the changes to the system requirements framework.

Furthermore, in certain aspects, the data configuration management system 104 utilizes an implementation agent 1122 to implement (automatically and/or through user device interaction) the controls and bring the data assets and/or the data processing operations of the entity into compliance with the changes to the system requirements framework. In certain aspects, the data configuration management system 104 utilizes the implementation agent 1122 to implement the controls to bring the data assets and/or the data processing operations of the entity into compliance with the changes to the system requirements framework via an interaction with the administrator client device 1124. For example, the data configuration management system 104 utilizes the implementation agent 1122 to automatically implement one or more modifications in response to an approval via the administrator client device 1124. In another example, the data configuration management system 104 provides recommended tasks to the administrator client device 1124 for implementing the one or more modifications via the administrator client device 1124. In some aspects, the regulatory change enactment engine 1116 can be implemented as described above with respect to FIG. 6.

In some aspects, the data configuration management system 104 utilizes one or more other configurations. Thus, the data configuration management system 104 can utilize several different computing devices (e.g., cloud-based devices or on premises devices) to perform various operations associated with implementing controls based on changes to system requirements frameworks. In additional aspects, the data configuration management system 104 performs one or more operations described herein by utilizing one or more software applications at one or more computing devices to generate instructions that cause one or more additional computing devices to perform one or more computing operations. As an example, a cloud-based computing application generates instructions that cause a server on premises of an organizational entity to utilize a framework change processor or a regulatory change enactment engine to bring the data assets and/or the data processing operations of the entity into compliance with the changes to the system requirements framework.

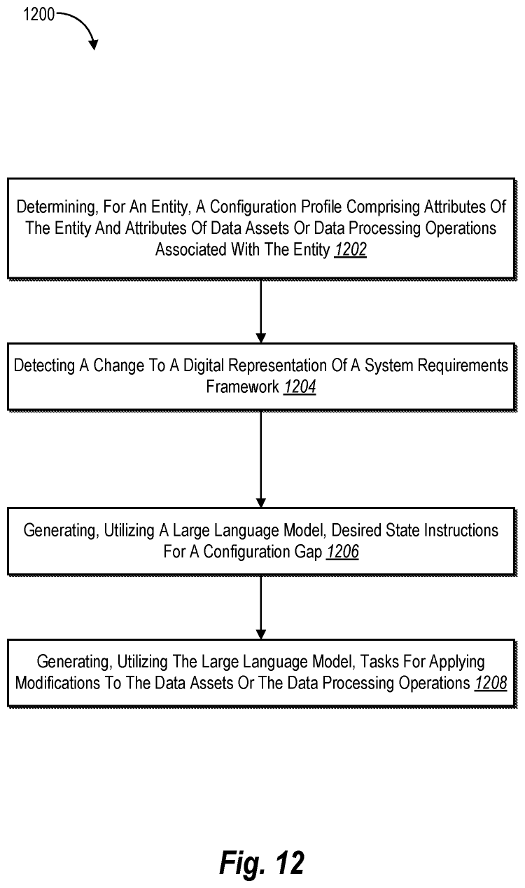

Turning now to FIG. 12, this figure illustrates an example flowchart of a process for classifying and modifying a digital content item according to the digital data requirements of a system requirements framework in accordance with one or more aspects. While FIG. 12 illustrates acts according to one aspect, alternative aspects may omit, add to, reorder, and/or modify any of the acts shown in FIG. 12. The acts of FIG. 12 can be performed as part of a method. Alternatively, a non-transitory computer readable medium can comprise instructions, that when executed by one or more processors, cause a computing device to perform the acts of FIG. 12. In still further aspects, a system can perform the acts of FIG. 12.

As shown, the series of acts 1200 includes an act 1202 of determining, for an entity, a configuration profile comprising attributes of the entity and attributes of data assets or data processing operations associated with the entity. In particular, the act 1202 can include determining for an entity, by at least one hardware processor, a configuration profile comprising attributes of the entity and attributes of one or more data assets or one or more data processing operations associated with the entity. In some aspects, act 1202 is implemented using one or more examples described above with respect to FIGS. 2-3.

Furthermore, the series of acts 1200 includes an act 1204 of detecting a chance to a digital representation of a system requirements framework. In particular the act 1204 can include detecting, by at the at least one hardware processor, a change to a digital representation of a system requirements framework comprising digital data requirements for handling specific data types. In some aspects, act 1204 is implemented using one or more examples described above with respect to FIG. 2.

Moreover, the series of acts 1200 includes an act 1206 of generating, utilizing a large language model, desired state instructions for a configuration gap. In particular the act 1206 can generating, utilizing a large language model, desired state instructions for a configuration gap comprising an indication of the change to the digital representation relative to the configuration profile. In some aspects, act 1206 is implemented using one or more examples described above with respect to FIGS. 4-5.

Further, the series of acts 1200 includes an act 1208 of generating, utilizing the large language model, tasks for applying modifications to the data assets or the data processing operations. In particular the act 1208 can include generating, utilizing the large language model, one or more tasks for applying one or more modifications to the one or more data assets or the one or more data processing operations according to the desired state instructions. In some aspects, act 1208 is implemented using one or more examples described above with respect to FIG. 6.

Further, in one or more aspects, the series of acts 1200 includes extracting the digital data requirements for handling specific data types from a digital data repository comprising a plurality of digital representations of a plurality of system requirements frameworks in response to detecting the change to the digital representation of the system requirements framework. In addition, in one or more aspects, the series of acts 1200 includes determining, based on the configuration profile, that the digital data requirements for handling the specific data types correspond to the one or more data assets or the one or more data processing operations by utilizing a knowledge graph comprising relationships between a plurality of data assets, a plurality of data processing operations, and the digital data requirements of the system requirements framework.

Furthermore, in one or more aspects, the series of acts 1200 includes determining, utilizing the large language model, a gap rule corresponding to one or more data objects representing the one or more data assets or the one or more data processing operations according to the digital data requirements. Additionally, in one or more aspects, the series of acts 1200 includes determining the configuration gap in response to applying the gap rule to one or more attribute values of the one or more data objects. Moreover, in one or more aspects, the series of acts 1200 includes generating, utilizing the large language model, the desired state instructions to modify the one or more controls in response to determining the configuration gap.

Further, in one or more aspects, the series of acts 1200 includes determining the configuration gap by comparing, via an application programming interface associated with the large language model, the digital representation of the system requirements framework to data objects representing the one or more data assets or the one or more data processing operations to determine a geographic location, an entity impact, an area of impact, or a data impact. Furthermore, in one or more aspects, the series of acts 1200 includes generating, utilizing an application programming interface associated with the large language model, the one or more tasks based on comparing the desired state instructions relative to a current state of the configuration profile. Moreover, in one or more aspects, the series of acts 1200 includes generating, utilizing the application programming interface associated with the large language model, the one or more modifications to the one or more data assets or the one or more data processing operations according to the desired state instructions.

Additionally, in one or more aspects, the series of acts 1200 includes determining, utilizing an application programming interface associated with the large language model, one or more control actions for installing one or more controls associated with handling data via the one or more data assets or the one or more data processing operations according to the change to the digital representation of the system requirements framework. Moreover, in one or more aspects, the series of acts 1200 includes generating the one or more tasks to implement the one or more control actions to install the one or more controls in connection with the one or more data assets or the one or more data processing operations.

In addition, in one or more aspects, the series of acts 1200 includes generating a task risk profile, a control recommendation, or a task recommendation associated with correcting the configuration gap by comparing, utilizing an application programming interface associated with the large language model, a current state of the configuration profile to a desired state of the configuration profile according to the change in the digital representation relative to the configuration profile. Additionally, in one or more aspects, the series of acts 1200 includes providing, for display via a graphical user interface of a computing device associated with the entity, the one or more tasks according to the desired state instructions. Furthermore, in one or more aspects, the series of acts 1200 includes detecting, in response to an interaction via the graphical user interface, an approval of the one or more tasks. Moreover, in one or more aspects, the series of acts 1200 includes causing, in response to the interaction, modification of the one or more data assets or the one or more data processing operations according to the one or more tasks.

In addition, in one or more aspects, the series of acts 1200 includes determining, by a regulatory change processor, a configuration profile comprising attributes of an entity and attributes of one or more data assets or one or more data processing operations associated with the entity. In some aspects, the series of acts is implemented using one or more examples described above with respect to FIGS. 2-3. Furthermore, in one or more aspects, the series of acts 1200 includes detecting, by the regulatory change processor, a change to a digital representation of a system requirements framework comprising digital data requirements for handling specific data types. In some aspects, the series of acts is implemented using one or more examples described above with respect to FIG. 2.

Moreover, in one or more aspects, the series of acts 1200 includes generating, by the regulatory change processor and utilizing a large language model, desired state instructions for a configuration gap comprising an indication of the change in the digital representation relative to the configuration profile. In some aspects, the series of acts is implemented using one or more examples described above with respect to FIGS. 4-5. Additionally, in one or more aspects, the series of acts 1200 includes providing, by a regulatory change enactment engine and for display via a graphical user interface, one or more tasks for applying one or more modifications to the one or more data assets or the one or more data processing operations according to the desired state instructions. In some aspects, the series of acts is implemented using one or more examples described above with respect to FIG. 6.

Further, in one or more aspects, the series of acts 1200 includes extracting, in response to detecting the change to the digital representation of the system requirements framework, the digital data requirements for handling specific data types from a software application comprising a plurality of digital representations of a plurality of system requirements frameworks. Moreover, in one or more aspects, the series of acts 1200 includes determining, by the regulatory change processor, a relationship between the digital data requirements for handling the specific data types and the one or more data assets or the one or more data processing operations by utilizing a knowledge graph comprising relationships between a plurality of data assets, a plurality of data processing operations, the digital data requirements of the system requirements framework. Additionally, in one or more aspects, the series of acts 1200 includes determining, based on the relationship, the configuration gap comprising a geographic location, an entity impact, an area of impact, or a data impact.

Further, in one or more aspects, the series of acts 1200 includes determining, utilizing the regulatory change processor, one or more controls in connection with one or more data objects representing the one or more data assets or the one or more data processing operations according to the digital data requirements. Moreover, in one or more aspects, the series of acts 1200 includes generating, utilizing the first computing device, the desired state instructions to modify the one or more controls in response to determining the configuration gap. In addition, in one or more aspects, the series of acts 1200 includes determining, utilizing an application programming interface associated with the large language model, a control recommendation associated with the one or more tasks based on comparing the desired state instructions relative to a current state of the configuration profile to determine the extent of the one or more modifications to the one or more data assets or the one or more data processing operations.

Moreover, in one or more aspects, the series of acts 1200 includes generating the one or more tasks by implementing one or more control actions to install one or more controls in connection with the one or more data assets or the one or more data processing operations. In addition, in one or more aspects, the series of acts 1200 includes detecting, in response to an interaction via the graphical user interface, an approval of the one or more tasks. Additionally, in one or more aspects, the series of acts 1200 includes modifying, utilizing the regulatory change enactment engine and in response to the interaction, the one or more data assets or the one or more data processing operations according to the one or more tasks.

Moreover, in one or more aspects, the series of acts 1200 includes detecting, by the at least one hardware processor, a change to a digital representation of a system requirements framework comprising digital data requirements for handling specific data types. In some aspects, the series of acts is implemented using one or more examples described above with respect to FIG. 2. Further, in one or more aspects, the series of acts 1200 includes determining for an entity, by the at least one hardware processor, a configuration profile comprising attributes of the entity and attributes of one or more data assets or one or more data processing operations associated with the entity. In some aspects, the series of acts is implemented using one or more examples described above with respect to FIGS. 2-3.

Further, in one or more aspects, the series of acts 1200 includes generating, utilizing a large language model, desired state instructions for a configuration gap comprising an indication of the change to the digital representation relative to the configuration profile. In some aspects, the series of acts is implemented using one or more examples described above with respect to FIGS. 4-5. In addition, in one or more aspects, the series of acts 1200 includes generating, utilizing the large language model, one or more tasks for applying one or more modifications to the one or more data assets or the one or more data processing operations according to the desired state instructions. In some aspects, the series of acts is implemented using one or more examples described above with respect to FIG. 6.

Furthermore, in one or more aspects, the series of acts 1200 includes determining, utilizing an application programming interface associated with the large language model, one or more control actions for installing one or more controls associated with handling data via the one or more data assets or the one or more data processing operations according to the change to the digital representation of the system requirements framework. Additionally, in one or more aspects, the series of acts 1200 includes generating the one or more tasks to implement the one or more control actions to install the one or more controls in connection with the one or more data assets or the one or more data processing operations. Moreover, in one or more aspects, the series of acts 1200 includes modifying the one or more data assets or the one or more data processing operations according to the one or more tasks.

Further, in one or more aspects, the series of acts 1200 includes detecting, in response to an interaction via the graphical user interface, an approval of the one or more tasks. Furthermore, in one or more aspects, the series of acts 1200 includes modifying, utilizing the regulatory change enactment engine and in response to the interaction, the one or more data assets or the one or more data processing operations according to the one or more tasks. Moreover, in one or more aspects, the series of acts 1200 includes generating, by the regulatory change enactment engine and for display via a graphical user interface, the one or more tasks comprising a control recommendation based on the potential severity of the impact associated with correcting the configuration gap. Additionally, in one or more aspects, the series of acts 1200 includes causing, in response to an approval interaction via the graphical user interface, modification of the one or more data assets or the one or more data processing operations according to the one or more tasks.

Moreover, in one or more aspects, the series of acts 1200 includes comparing, utilizing an application programming interface associated with the large language model, a current state of the configuration profile to the desired state instructions to determine a desired state of the configuration profile. In addition, in one or more aspects, the series of acts 1200 includes generating a risk profile, a control recommendation, or a task recommendation to modify the one or more data assets or one or more data processing operations associated with the entity to according to the desired state of the configuration profile.

Aspects of the present disclosure may comprise or utilize a special purpose or general-purpose computer including computer hardware, such as, for example, one or more processors and system memory, as discussed in greater detail below. Aspects within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, aspects of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some aspects, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. One will appreciate that one or more computing devices such as the computing device 1300 may implement the system(s) of FIG. 1. As shown by FIG. 13, the computing device 1300 can comprise a processor 1302, a memory 1304, a storage device 1306, an I/O interface 1310, and a communication interface 1310, which may be communicatively coupled by way of a communication infrastructure 1312. In certain aspects, the computing device 1300 can include fewer or more components than those shown in FIG. 13. Components of the computing device 1300 shown in FIG. 13 will now be described in additional detail.

In one or more aspects, the processor 1302 includes hardware for executing instructions, such as those making up a computer program. As an example, and not by way of limitation, to execute instructions for dynamically modifying workflows, the processor 1302 may retrieve (or fetch) the instructions from an internal register, an internal cache, the memory 1304, or the storage device 1306 and decode and execute them. The memory 1304 may be a volatile or non-volatile memory used for storing data, metadata, and programs for execution by the processor(s). The storage device 1306 includes storage, such as a hard disk, flash disk drive, or other digital storage device, for storing data or instructions for performing the methods described herein.

The I/O interface 1308 allows a user to provide input to receive output from, and otherwise transfer data to and receive data from computing device 1300. The I/O interface 1308 may include a mouse, a keypad or a keyboard, a touch screen, a camera, an optical scanner, network interface, modem, other known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain aspects, the I/O interface 1308 is configured to provide graphical data to a display for presentation to a user. The graphical data may be representative of one or more graphical user interfaces and/or any other graphical content as may serve a particular aspect.

The communication interface 1310 can include hardware, software, or both. In any event, the communication interface 1310 can provide one or more interfaces for communication (such as, for example, packet-based communication) between the computing device 1300 and one or more other computing devices or networks. As an example, and not by way of limitation, the communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1310 may facilitate communications with various types of wired or wireless networks. The communication interface 1310 may also facilitate communications using various communication protocols. The communication infrastructure 1312 may also include hardware, software, or both that couples components of the computing device 1300 to each other. For example, the communication interface 1310 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary aspects thereof. Various aspects and aspects of the present disclosure(s) are described with reference to details discussed herein, and the accompanying drawings illustrate the various aspects. The description above and drawings are illustrative of the disclosure and are not to be construed as limiting the disclosure. Numerous specific details are described to provide a thorough understanding of various aspects of the present disclosure.

The present disclosure may be embodied in other specific forms without departing from its spirit or essential characteristics. The described aspects are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
determining for an entity, by at least one hardware processor, a configuration profile comprising attributes of the entity and attributes of one or more data assets or one or more data processing operations associated with the entity;
detecting, by at the at least one hardware processor, a change to a digital representation of a system requirements framework comprising digital data requirements for handling specific data types;
generating, utilizing a large language model, desired state instructions for a configuration gap comprising an indication of the change to the digital representation relative to the configuration profile; and
generating, utilizing the large language model, one or more tasks for applying one or more modifications to the one or more data assets or the one or more data processing operations according to the desired state instructions.

2. The method of claim 1, wherein generating the desired state instructions comprises extracting the digital data requirements for handling specific data types from a digital data repository comprising a plurality of digital representations of a plurality of system requirements frameworks in response to detecting the change to the digital representation of the system requirements framework.

3. The method of claim 1, further comprising determining, based on the configuration profile, that the digital data requirements for handling the specific data types correspond to the one or more data assets or the one or more data processing operations by utilizing a knowledge graph comprising relationships between a plurality of data assets, a plurality of data processing operations, and the digital data requirements of the system requirements framework.

4. The method of claim 1, wherein generating the desired state instructions comprises:
determining, utilizing the large language model, a gap rule corresponding to one or more data objects representing the one or more data assets or the one or more data processing operations according to the digital data requirements;
determining the configuration gap in response to applying the gap rule to one or more attribute values of the one or more data objects; and
generating, utilizing the large language model, the desired state instructions to modify the one or more controls in response to determining the configuration gap.

5. The method of claim 1, wherein generating the desired state instructions comprises determining the configuration gap by comparing, via an application programming interface associated with the large language model, the digital representation of the system requirements framework to data objects representing the one or more data assets or the one or more data processing operations to determine a geographic location, an entity impact, an area of impact, or a data impact.

6. The method of claim 1, further comprising:
generating, utilizing an application programming interface associated with the large language model, the one or more tasks based on comparing the desired state instructions relative to a current state of the configuration profile; and
generating, utilizing the application programming interface associated with the large language model, the one or more modifications to the one or more data assets or the one or more data processing operations according to the desired state instructions.

7. The method of claim 1, wherein generating the one or more tasks comprises:
determining, utilizing an application programming interface associated with the large language model, one or more control actions for installing one or more controls associated with handling data via the one or more data assets or the one or more data processing operations according to the change to the digital representation of the system requirements framework; and
generating the one or more tasks to implement the one or more control actions to install the one or more controls in connection with the one or more data assets or the one or more data processing operations.

8. The method of claim 1, wherein generating the one or more tasks comprises generating a task risk profile, a control recommendation, or a task recommendation associated with correcting the configuration gap by comparing, utilizing an application programming interface associated with the large language model, a current state of the configuration profile to a desired state of the configuration profile according to the change in the digital representation relative to the configuration profile.

9. The method of claim 1, further comprising:
providing, for display via a graphical user interface of a computing device associated with the entity, the one or more tasks according to the desired state instructions;
detecting, in response to an interaction via the graphical user interface, an approval of the one or more tasks; and
causing, in response to the interaction, modification of the one or more data assets or the one or more data processing operations according to the one or more tasks.

10. A system comprising:
one or more non-transitory computer readable media comprising a digital data repository; and
at least one processor configured to cause the system to:
determine, by a regulatory change processor, a configuration profile comprising attributes of an entity and attributes of one or more data assets or one or more data processing operations associated with the entity;
detect, by the regulatory change processor, a change to a digital representation of a system requirements framework comprising digital data requirements for handling specific data types;
generate, by the regulatory change processor and utilizing a large language model, desired state instructions for a configuration gap comprising an indication of the change in the digital representation relative to the configuration profile; and
provide, by a regulatory change enactment engine and for display via a graphical user interface, one or more tasks for applying one or more modifications to the one or more data assets or the one or more data processing operations according to the desired state instructions.

11. The system of claim 10, wherein the at least one computer processor is further configured to cause the system to extract, in response to detecting the change to the digital representation of the system requirements framework, the digital data requirements for handling specific data types from a software application comprising a plurality of digital representations of a plurality of system requirements frameworks.

12. The system of claim 10, wherein the at least one computer processor is further configured to cause the system to:
determine, by the regulatory change processor, a relationship between the digital data requirements for handling the specific data types and the one or more data assets or the one or more data processing operations by utilizing a knowledge graph comprising relationships between a plurality of data assets, a plurality of data processing operations, the digital data requirements of the system requirements framework; and
determine, based on the relationship, the configuration gap comprising a geographic location, an entity impact, an area of impact, or a data impact.

13. The system of claim 10, wherein the at least one computer processor is further configured to cause the system to:
determine, utilizing the regulatory change processor, one or more controls in connection with one or more data objects representing the one or more data assets or the one or more data processing operations according to the digital data requirements; and
generate, utilizing the first computing device, the desired state instructions to modify the one or more controls in response to determining the configuration gap.

14. The system of claim 10, wherein the at least one computer processor is further configured to cause the system to determine, utilizing an application programming interface associated with the large language model, a control recommendation associated with the one or more tasks based on comparing the desired state instructions relative to a current state of the configuration profile to determine the extent of the one or more modifications to the one or more data assets or the one or more data processing operations.

15. The system of claim 10, wherein the at least one computer processor is further configured to cause the system to generate the one or more tasks by implementing one or more control actions to install one or more controls in connection with the one or more data assets or the one or more data processing operations.

16. The system of claim 10, wherein the at least one computer processor is further configured to:
detect, in response to an interaction via the graphical user interface, an approval of the one or more tasks; and
modify, utilizing the regulatory change enactment engine and in response to the interaction, the one or more data assets or the one or more data processing operations according to the one or more tasks.

17. A non-transitory computer readable medium comprising instructions that, when executed by at least one computer processor, cause the at least one computer processor to:
detect, by the at least one hardware processor, a change to a digital representation of a system requirements framework comprising digital data requirements for handling specific data types;
determine for an entity, by the at least one hardware processor, a configuration profile comprising attributes of the entity and attributes of one or more data assets or one or more data processing operations associated with the entity;
generate, utilizing a large language model, desired state instructions for a configuration gap comprising an indication of the change to the digital representation relative to the configuration profile; and
generate, utilizing the large language model, one or more tasks for applying one or more modifications to the one or more data assets or the one or more data processing operations according to the desired state instructions.

18. The non-transitory computer readable medium of claim 17, further comprising instructions that, when executed by the at least one computer processor, cause the at least one computer processor to:
determine, utilizing an application programming interface associated with the large language model, one or more control actions for installing one or more controls associated with handling data via the one or more data assets or the one or more data processing operations according to the change to the digital representation of the system requirements framework;
generate the one or more tasks to implement the one or more control actions to install the one or more controls in connection with the one or more data assets or the one or more data processing operations; and
modify the one or more data assets or the one or more data processing operations according to the one or more tasks.

19. The non-transitory computer readable medium of claim 17, further comprising instructions that, when executed by the at least one computer processor, cause the at least one computer processor to:
generate, by the regulatory change enactment engine and for display via a graphical user interface, the one or more tasks comprising a control recommendation based on the potential severity of the impact associated with correcting the configuration gap; and
cause, in response to an approval interaction via the graphical user interface, modification of the one or more data assets or the one or more data processing operations according to the one or more tasks.

20. The non-transitory computer readable medium of claim 17, further comprising instructions that, when executed by the at least one computer processor, cause the at least one computer processor to:
compare, utilizing an application programming interface associated with the large language model, a current state of the configuration profile to the desired state instructions to determine a desired state of the configuration profile; and
generate a risk profile, a control recommendation, or a task recommendation to modify the one or more data assets or one or more data processing operations associated with the entity to according to the desired state of the configuration profile.
